(19) United States
(12) Patent Application Publication
(10) Pub. No.: US 2024/0013675 A1
(43) Pub. Date: Jan. 11, 2024

(54) A COMPUTERIZED METHOD FOR FACILITATING MOTOR LEARNING OF MOTOR SKILLS AND SYSTEM THEREOF

(71) Applicant: AGT INTERNATIONAL GMBH, Zurich (CH)

(72) Inventors: Lasse LEHMANN, Weiterstadt (DE); Agoston TOROK, Darmstadt (DE); Galit PELED, Ramat Hasharon (IL)

(21) Appl. No.: 18/247,507

(22) PCT Filed: Oct. 1, 2021
(86) PCT No.: PCT/IL2021/051187

§ 371 Date: Mar. 31, 2023

Related U.S. Application Data
(60) Provisional application No. 63/086,360, filed on Oct. 1, 2020.
(60) Provisional application No. 63/165,962, filed on Mar. 25, 2021.

(30) Foreign Application Priority Data
Feb. 3, 2021 (WO) PCT/IL2021/050129

(51) Int. Cl. G09B 19/00; G09B 5/06; G06V 20/40; G06V 40/20; G06T 11/00

(52) U.S. Cl. CPC G09B 19/003; G09B 5/065; G06V 20/49; G06V 40/23; G06T 11/00; G09B 19/0015

(57) ABSTRACT

A method for facilitating motor learning of a motor skill by a trainee in relation to a trainer's motor skill is provided. The method comprises providing a trainer video including a trainer's motor skill that include a plurality of consecutive moves. The trainer video is divided into a plurality of selectable segments. Each selectable segment includes at least one move of the plurality of consecutive moves. The method further includes receiving data indicative of a selected segment of the plurality of selectable segments displayed to the trainee, receiving a trainee video comprising at least one trainee move, processing the at least one trainee move with respect to at least one corresponding move included in the selected segment to obtain a segment performance score, indicative of a performance of the at least one trainee move; and based on the segment performance score, generating and providing at least one feedback.

### TECHNICAL FIELD

The presently disclosed subject matter relates to the motor skills learning field, and, more particularly, to facilitating the learning of motor skills using a computing device.

### BACKGROUND

In a computerized process of training a user to perform motor skills, such as a user that wishes to learn a dance from a dancing teacher, the user watches the dancing teacher perform the dance, and performs the same dance by mimicking the teacher's dance. Performance of the dance is tracked, e.g. by a camera or sensors attached to the user, processed, and then feedback of the performed dance is provided to the user. In some known solutions, the system provides feedback to the user by reporting a set of measurements related to the dance performed by the user. However, in many known systems, interpreting the measurements, and deciding how exactly the dance execution should be improved, is left to the user. Hence, it is desired to provide the user with a more accurate evaluation of his dance, and also to provide guiding feedback on the dance that was performed.

### SUMMARY OF THE INVENTION

One goal of motor learning by a trainee from a trainer is to achieve optimized performance of a motor skill performed by the trainer, at a rate of success and precision. Continuous practice of the motor skill by the trainee, while mimicking the trainer, may eventually result in an improved performance of the motor skill. However, it is desired to optimize the learning process, while achieving an improved performance as quickly as possible. In order to optimize this process, it is advantageous that the trainee's learning attempts are analyzed in a precise manner, and that focused feedback is provided during the learning process.

In addition, in cases where the motor skill includes a series of moves, as opposed to a single move, it may be advantageous to divide the motor skill into smaller segments, and teach the trainee each segment, or a combination of several segments, individually, and to provide the trainee with feedback on the segments. Enabling the trainee to repeat learning of segments of the motor skill, as opposed to learning of the whole motor skill, and providing feedback for learning attempts on the segments, may facilitate the trainee to improve his performance of the entire motor skill.

It should be noted that for purpose of illustration only, the following description is provided for a dance motor skill. However, various examples of motor skills are applicable to the presently disclosed subject matter, such as yoga, fitness, boxing, or different katal.

According to one aspect of the presently disclosed subject matter there is provided a computerized method for facilitating motor learning of a motor skill by a trainee in relation to a trainer's motor skill, the method comprising:
providing a trainer video, the trainer video including a trainer's motor skill, the trainer's motor skill including a plurality of consecutive moves, wherein the trainer video is divided into a plurality of selectable segments to be displayed to the trainee's device, wherein each selectable segment includes at least one move of the plurality of consecutive moves;
receiving data indicative of a selected segment of the plurality of selectable segments displayed to the trainee;
receiving a trainee video comprising at least one trainee move;
processing the at least one trainee move with respect to at least one corresponding move included in the selected segment to obtain a segment performance score, indicative of a performance of the at least one trainee move in relation to the at least one corresponding move of the selected segment;
based on the segment performance score, generating at least one feedback; and
providing the at least one generated feedback to the trainee's device;
whereby the provided feedback facilitates the trainee to improve a performance of the motor skill with respect to the trainer's motor skill.

In addition to the above features, the computerized method according to this aspect of the presently disclosed subject matter can comprise one or more of features (i) to (xxvi) listed below, in any desired combination or permutation which is technically possible:
(i). at least one selectable segment includes at least one manipulated form of a move of the plurality of consecutive moves, wherein providing a trainer video further comprises providing an indication of the manipulation;
(ii). At least one manipulated form of the move is a slow-motion form of the move.
(iii). At least one manipulated form of the move includes superimposing a visual guidance on the trainer video.
(iv). At least a first and second segments of the selectable segments include a move of the plurality of consecutive moves and a manipulated form of the move, respectively.
(v). Each selectable segment is associated with a segment duration, and wherein at least two selectable segments are associated with different segment durations.
(vi). At least one selectable segment is an aggregated segment forming an aggregation of at least two other selectable segments, and wherein the aggregated segment has a longer duration than the duration of the at least two other selectable segments.
(vii). At least two selectable segments include at least one overlapping move.
(viii). The trainer video is divided into a hierarchy of the plurality of selectable segments representing a hierarchical learning flow, wherein a selectable segment at a higher level of the hierarchy includes: (i) all the moves included in at least one lower level selectable segment of the hierarchy and, (ii) at least one move of the plurality of consecutive moves that is not included in the at least one lower level selectable segment of the hierarchy.
(ix). Processing the at least one trainee move is done with respect to at least one aspect of the performance of the at least one trainee move, wherein the at least one aspect is selected from a group comprising: similarity, timing, and motion dynamics, or a combination thereof.
(x). At least one generated feedback is audio feedback, textual feedback, and/or visual feedback.
(xi). At least one generated feedback is visual feedback, the method further comprising:
   determining if the segment performance score exceeds a pre-defined threshold;
   if in the affirmative, generating feedback comprising a manipulated version of the trainee video; and
   providing the generated feedback to the trainee's device.
(xii). At least one generated feedback includes at least general feedback pertaining to the performance of the motor skill and specific feedback pertaining to the performance of the selected segment.
(xiii). The generated at least one feedback pertains the at least one aspect of the performance.
(xiv). A trainee move of the least one trainee move is defined by a set of joints, the method further comprising:
   selecting, based on the at least one aspect of the performance, a joint included in a processed trainee move to cut out;
   generating visual feedback including at least the selected joint; and
   providing the generated visual feedback to the trainee's device.
(xv). Selecting the joint can be done in real time.
(xvi). Generating the at least one feedback further comprises:
   identifying at least two candidate feedbacks; and
   providing the at least two candidate feedbacks to the trainee's device.
(xvii). The computerized method further comprising:
   filtering out at least one candidate feedback based on a history of feedbacks provided to the trainee; and
   providing the at least two candidate feedbacks to the trainee's device without the filtered out at least one candidate.
(xviii). The computerized method further comprising:
   associating a priority to at least one of the at least two candidate feedbacks based on a pre-set priority rules; and
   providing at least one candidate feedback having the highest priority to the trainee's device.
(xix). The pre-set priority rules are selected from a group comprising: affected body parts of the trainee in the at least one trainee move, specificity of the feedback, history of provided feedbacks, and affected part of the move.
(xx). The computerized method further comprising:
   customizing the at least one generated feedback; and
   providing the at least one customized feedback to the trainee's device.
(xxi). At least one generated feedback includes at least the trainee video or a part thereof, the method further comprising:
   based on the at least one processed trainee move, obtaining at least one visual cue;
   determining, in real time, a location on the received trainee video suitable for superimposing the at least one obtained visual cue; and
   customizing the generated feedback by superimposing the at least one obtained visual cue on the trainee video at the determined location.
(xxii). The computerized method further comprising:
   determining a time duration for superimposing the at least one obtained visual cue;
   and superimposing the at least one obtained visual cue on the trainee video for the determined time duration.
(xxiii). The generated feedback is provided in a manner facilitating displaying the generated feedback, in real time, simultaneously to displaying of the selected segment.
(xxiv). The trainee video is captured by the trainee's device, the method further comprising:
   providing a visual calibration shape to be displayed on the trainee's device, wherein displaying the visual calibration shape facilitates calibration of the captured trainee video with a trainee's position; and
   receiving the trainee video.
(xxv). The motor learning of the motor skill, comprising executing, in a repetitive manner, the stages of the computerized method, wherein, in each current iteration of the execution, the method comprises:
   providing the trainer video;
   receiving the data indicative of a current selected segment displayed to the trainee;
   receiving the current trainee video;
   processing the at least one trainee move to obtain a current segment performance score;
   based on the current segment performance score, generating at least one feedback; and
   providing the at least one generated feedback to the trainee's device.
(xxvi). The computerized method comprising:
   determining a next selected segment of the plurality of selectable segments to be displayed to the trainee; and
   providing data indicative of the next selected segment;
   thereby facilitating displaying the next selected segment upon completion of displaying the current selected segment.

According to another aspect of the presently disclosed subject matter there is provided a computerized system for facilitating motor learning of a motor skill by a trainee in relation to a trainer's motor skill, the system comprising a processing and memory circuitry (PMC) configured to:
provide a trainer video, the trainer video including a trainer's motor skill, the trainer's motor skill including a plurality of consecutive moves, wherein the trainer video is divided into a plurality of selectable segments to be displayed to the trainee's device, wherein each selectable segment includes at least one move of the plurality of consecutive moves;
receive data indicative of a selected segment of the plurality of selectable segments displayed to the trainee;
receive a trainee video comprising at least one trainee move;
process the at least one trainee move with respect to at least one corresponding move included in the selected segment to obtain a segment performance score, indicative of a performance of the at least one trainee move in relation to the at least one corresponding move of the selected segment;
based on the segment performance score, generate at least one feedback; and
provide the at least one generated feedback to the trainee's device;
whereby the provided feedback facilitates the trainee to improve a performance of the motor skill with respect to the trainer's motor skill.

According to another aspect of the presently disclosed subject matter there is provided a non-transitory computer readable storage medium tangibly embodying a program of instructions that, when executed by a computer, cause the computer to perform a method for facilitating communication with a user device of a user associated with a property in a property location, the method comprising:
providing a trainer video, the trainer video including a trainer's motor skill, the trainer's motor skill including a plurality of consecutive moves, wherein the trainer video is divided into a plurality of selectable segments to be displayed to the trainee's device, wherein each selectable segment includes at least one move of the plurality of consecutive moves;
receiving data indicative of a selected segment of the plurality of selectable segments displayed to the trainee;
receiving a trainee video comprising at least one trainee move;
processing the at least one trainee move with respect to at least one corresponding move included in the selected segment to obtain a segment performance score, indicative of a performance of the at least one trainee move in relation to the at least one corresponding move of the selected segment;
based on the segment performance score, generating at least one feedback; and
providing the at least one generated feedback to the trainee's device;
whereby the provided feedback facilitates the trainee to improve a performance of the motor skill with respect to the trainer's motor skill.

According to another aspect of the presently disclosed subject matter there is provided in a trainee device, a computerized method for facilitating motor learning of a motor skill by a trainee in relation to a trainer's motor skill, the method comprising:
providing a trainer video, the trainer video including a trainer's motor skill, the trainer's motor skill including a plurality of consecutive moves, wherein the trainer video is divided into a plurality of selectable segments to be displayed to the trainee's device, wherein each selectable segment includes at least one move of the plurality of consecutive moves;
displaying the provided trainer video;
receiving data indicative of a selected segment of the plurality of selectable segments displayed to the trainee;
capturing a trainee video comprising at least one trainee move;
processing the at least one trainee move with respect to at least one corresponding move included in the selected segment to obtain a segment performance score, indicative of a performance of the at least one trainee move in relation to the at least one corresponding move of the selected segment;
based on the segment performance score, generating at least one feedback; and
providing the at least one generated feedback to the trainee's device;
whereby the provided feedback facilitates the trainee to improve a performance of the motor skill with respect to the trainer's motor skill.

This aspect of the disclosed subject matter can comprise one or more of features (i) to (iivi) listed above with respect to the system, mutatis mutandis, in any desired combination or permutation which is technically possible.

In accordance with an aspect of the presently disclosed subject matter, there is provided a computerized method for scoring performance of a move of a trainee in a trainee frame input in relation to a move of a trainer in a trainer video, wherein the trainer move includes at least one trainer keyframe, the method comprising:
obtaining a trainee frame input comprising a trainee move, the trainee move comprising a plurality of trainee frames;
based on the at least one trainer keyframe, processing the plurality of trainee frames to provide a move performance score, indicative of the performance of the trainee move in relation to the trainer move, with respect to at least one aspect of the performance, the processing comprising:
selecting for the at least one trainer keyframe, according to a selection criterion, at least one trainee frame of the plurality trainee frames that correspond to the at least one trainer keyframe, giving rise to at least one candidate;
based on the at least one trainer keyframe and the at least one candidate, calculating at least one aspect score of the at least one aspect; and
transforming the at least one calculated aspect score, giving rise to the move performance score; and
based on the move performance score, providing feedback to the trainee;
whereby, the provided feedback facilitates the trainee to improve performance of a future move with respect to the trainer move.

In addition to the above features, the computerized method according to this aspect of the presently disclosed subject matter can comprise one or more of features (i) to (xix) listed below, in any desired combination or permutation which is technically possible:
(i) wherein the selection criterion is a time criterion, and wherein selecting the at least one trainee frame comprises selecting at least one trainee keyframe in a time window in the trainee frame input that is around a time point of the at least one trainer keyframe in the trainer video;
(ii) wherein the at least one aspect is a similarity aspect, and wherein the at least one trainer keyframe includes body parts of the trainer and the at least one candidate include body parts of the trainee, and wherein calculating the similarity aspect score further comprises:
   computing at least one angular difference between at least one body part included in the at least one trainer keyframe and at least one corresponding body part included in the at least one candidate; and
   calculating the similarity aspect score, based on the computed at least one angular difference;
(iii) wherein computing the angular differences comprises computing at least one parameter selected from a group of parameters comprising: absolute angular difference, cosine distance, and a learned distance;
(iv) wherein the at least one trainer keyframe is associated with a predefined keyframe format, the method further comprising:
pre-processing the at least one candidate in accordance with the predefined keyframe format, giving rise to at least one formatted candidate, such that the at least one formatted candidate is formatted according to the predefined format; and
computing the angular differences between the body parts in the at least one trainer keyframe and body parts in the at least one formatted candidate;
(v) wherein at least one body part of the at least one body part of the trainer is associated with a respective weight, and wherein the method further comprises:
computing the angular difference between the at least one body part and at least one corresponding body part of the trainee; and
associating the computed angular difference with the respective weight; and
calculating the similarity aspect score, based on the computed angular difference, according to the associated respective weight;
(vi) wherein at least one body part is associated with a zero weight.
(vii) wherein the trainer move includes at least two trainer keyframes, wherein the at least one aspect is a timing aspect pertaining to at least two trainer keyframes, and wherein prior to calculating the timing aspect score, the method further comprises:
obtaining, for each of the at least two candidates, a respective matching score, the matching score being indicative of a likelihood of match between a candidate and a trainer keyframe; and
wherein calculating the timing aspect score further comprises:
   based on a trainer time interval in the trainer video, the trainer time interval includes the at least two trainer keyframes, determining a corresponding trainee time interval in the trainee frame input, the corresponding trainee time interval including at least two successive candidates having respective matching scores, and
   calculating a timing score for the at least two successive candidates, with respect to one or more timing parameters;
   wherein transforming the calculated timing score further comprises fusing the matching scores and the calculated respective timing score of the candidates, giving rise to the move performance score;
(viii) wherein the timing parameter is an out-of-sync parameter pertaining to an order of appearance of the at least two trainee frames in the sequence when compared to an order of appearance of the at least two trainer keyframes, and wherein calculating the respective timing score further comprises:
determining, for at least two trainee frames of the sequence of keyframes, an out-of-sync parameter score, and
calculating the timing score of each respective trainee frame based on at least the determined out-of-sync parameter scores;
(ix) wherein the timing parameter is a time offset parameter, wherein a time offset that pertains to an offset between a time that a trainer keyframe appears in the trainer video, and a time that the candidate appears in the trainee frame input, and wherein calculating the respective timing score further comprises:
determining, for a trainer keyframe and a corresponding candidate, a time offset; and
calculating the timing score based on the determined time offset scores;
(x) wherein the at least one matching score is a similarity aspect score;
(xi) wherein the at least one matching score is a motion dynamics score;
(xii) wherein the at least one matching score is an aggregation of the similarity aspect score and a motion dynamics score;
(xiii) wherein calculating the timing score is based on at least two timing parameters, wherein at least one of the timing parameters is associated with a weight, and wherein calculating the timing score further comprises calculating the timing score based on the associated weight;
(xiv) wherein prior to fusing the matching score and the timing score, the method further comprises:
with respect to at least one candidate of the at least two successive candidates, aggregating the obtained matching score and the calculated timing score of the candidates to provide an aggregated optimality score;
for at least one trainer keyframe, selecting a matching trainee frame by selecting one candidate having a highest aggregated optimality score; and
fusing the matching score and the timing score of the matching trainee frames, giving rise to a move performance score;
(xv) wherein the trainer move includes at least two trainer keyframes, and wherein the at least one aspect being a motion dynamics aspect, and wherein:
based on a trainer time interval included in the trainer video, the trainer time interval includes the at least two trainer keyframes, determining a corresponding trainee time interval in the trainee frame input, the determined corresponding trainee time interval including at least two trainee frames;
based on at least one motion feature extracted from the at least two trainer keyframes included in the trainer time interval, determining a motion dynamics score for the at least two trainee frames;
wherein the at least one motion feature is indicative of movement transformation between two keyframes;
(xvi) at least one trainer keyframe of the at least two trainer keyframes is associated with a respective matching trainee frame, and wherein the determined corresponding trainee time interval includes at least one matching trainee frame to the at least two trainer keyframes;
(xvii) wherein each of the trainer and corresponding trainee time intervals is associated with a window size, wherein the window size associated with the corresponding trainee time interval is different to the window size associated with the trainer time interval;
calculating a difference between the window sizes of the trainer and corresponding trainee time intervals;
normalizing the trainee frames included in the trainee time interval in accordance with the calculated difference; and
determining the at least one motion feature in the normalized trainee frames.
(xviii) wherein the at least one motion feature is selected from a group of features comprising: peak motion feature, velocity motion feature, pose motion feature, relative change motion feature, and turn motion feature;
(xix) wherein processing the plurality of trainee frames to provide the move performance score is done with respect to at least first and second aspects, and wherein transforming the at least first and second calculated aspect scores further comprises:
for at least the first calculated aspect score of the first aspect, determining a respective transformation function, the transformation function being determined based on one or more conditions pertaining at least to the second calculated aspect score of the second aspect; and
fusing the at least first and second aspects scores, based on the respective transformation functions, giving rise to the move performance score;

According to another aspect of the presently disclosed subject matter, there is provided a system for scoring performance of a move of a trainee in a trainee frame input in relation to a move of a trainer in a trainer video, wherein the trainer move includes at least one trainer keyframe, by a processor and memory circuitry (PMC), the processor being configured to:
obtain a trainee frame input comprising a trainee move, the trainee move comprising a plurality of trainee frames;
based on the at least one trainer keyframes, process the plurality of trainee frames to provide a move performance score, indicative of the performance of the trainee move in relation to the trainer move, with respect to at least one aspect of the performance, the process comprising:
   selecting for the at least one trainer keyframe, according to a selection criterion, at least one trainee frame of the plurality trainee frames that correspond to the at least one trainer keyframe, giving rise to at least one candidate;
   based on the at least one trainer keyframe and the at least one candidate, calculate at least one aspect score of the at least one aspect; and
   transform the at least one calculated aspect score, giving rise to the move performance score; and
based on the move performance score, provide feedback to the trainee;
whereby, the provided feedback facilitates the trainee to improve performance of a future move with respect to the trainer move.

According to another aspect of the presently disclosed subject matter, there is yet further provided a non-transitory computer readable storage medium tangibly embodying a program of instructions that, when executed by a computer, cause the computer to perform a method for scoring performance of a move of a trainee in a trainee frame input in relation to a move of a trainer in a trainer video, wherein the trainer move includes at least one trainer keyframe, the method comprising:
obtaining a trainee frame input comprising a trainee move, the trainee move comprising a plurality of trainee frames;
based on the at least one trainer keyframe, processing the plurality of trainee frames to provide a move performance score, indicative of the performance of the trainee move in relation to the trainer move, with respect to at least one aspect of the performance, the processing comprising:
   selecting for the at least one trainer keyframe, according to a selection criterion, at least one trainee frame of the plurality trainee frames that correspond to the at least one trainer keyframe, giving rise to at least one candidate;
   based on the at least one trainer keyframe and the at least one candidate, calculating at least one aspect score of the at least one aspect; and
   transforming the at least one calculated aspect score, giving rise to the move performance score; and
based on the move performance score, providing feedback to the trainee;
whereby the provided feedback facilitates the trainee to improve performance of a future move with respect to the trainer move.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an environment comprising a learning system 100, in accordance with certain embodiments of the presently disclosed subject matter.

FIG. 2 illustrates a high-level functional block diagram of PMC 120, in accordance with certain embodiments of the presently disclosed subject matter.

FIG. 3 illustrates an exemplary screenshot of motor skill, in accordance with certain embodiments of the presently disclosed subject matter;

FIG. 3A illustrates an exemplary screenshot of visual guidance, in accordance with certain embodiments of the presently disclosed subject matter;

FIG. 3B illustrates an exemplary screenshot of a trainee's video, in accordance with certain embodiments of the presently disclosed subject matter;

FIG. 4 illustrates a generalized flow chart of operations performed by PMC 120, in accordance with certain embodiments of the presently disclosed subject matter;

FIG. 5 illustrates another exemplary screenshot, in accordance with certain embodiments of the presently disclosed subject matter;

FIG. 6 illustrates exemplary videos including keyframes, in accordance with certain embodiments of the presently disclosed subject matter;

block FIG. 7 illustrates a generalized flow chart of operations performed by PMC 120, in accordance with certain embodiments of the presently disclosed subject matter;

FIG. 8 illustrates exemplary timelines of the trainer keyframes and the trainee frames in the respective videos, in accordance with certain embodiments of the presently disclosed subject matter;

FIG. 9 illustrates two keyframes in accordance with certain embodiments of the presently disclosed subject matter;

FIG. 10 illustrates a generalized flow chart of analysing keyframe similarity, in accordance with certain embodiments of the presently disclosed subject matter;

FIG. 11 illustrates other exemplary timelines of the trainer keyframes and the trainee frames in the respective videos, in accordance with certain embodiments of the presently disclosed subject matter;

FIG. 12 illustrates exemplary timelines of the trainer keyframes and the trainee frames illustrating an out-of-sync timing parameter, in accordance with certain embodiments of the presently disclosed subject matter;

FIG. 13 illustrates a generalized flow chart of analysing keyframe timing, in accordance with certain embodiments of the presently disclosed subject matter;

FIG. 14 illustrates an exemplary matrix of timing scores, in accordance with certain embodiments of the presently disclosed subject matter;

FIG. 15 illustrates a generalized flow chart of analysing motion dynamics, in accordance with certain embodiments of the presently disclosed subject matter;

FIG. 16 illustrates exemplary videos including keyframes, in accordance with certain embodiments of the presently disclosed subject matter;

FIG. 17 illustrates an example of evaluating a move based on several aspects, in accordance with certain embodiments of the presently disclosed subject matter;

FIG. 18 illustrates an exemplary screenshot, in accordance with certain embodiments of the presently disclosed subject matter; and

FIG. 19 illustrates another exemplary screenshot, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “providing”, “determining”, “selecting”, “obtaining”, “scoring”, “calculating”, “transforming”, “fusing”, “pre-processing”, “associating”, “aggregating”, “normalizing” “presenting”, “comparing”, “displaying”, “prioritizing”, “facilitating”, “superimposing”, “learning”, “organizing”, “proceeding”, “calibrating”, “receiving”, “detecting”, “generating”, “manipulating”, “identifying”, “filtering out”, “customizing” or the like, refer to the action(s) and/or process(es) of a computer that manipulate and/or transform data into other data, said data represented as physical, such as electronic, quantities and/or said data representing the physical objects.

The terms “computer”, “computer/computerized device, “computer/computerized system”, or the like, as disclosed herein, should be broadly construed to include any kind of hardware-based electronic device with data processing capabilities including, by way of non-limiting example, the processor and memory circuitry (PMC) 120 disclosed in the present application. The processing circuitry can comprise for example, one or more computer processors operatively connected to computer memory, loaded with executable instructions for executing operations, as further described below.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

In known methods of learning motor skills, by a trainee user (referred to also as a trainee throughout and below), learning the motor skills requires the trainee to observe and mimic the motor skill usually comprised of an atomic move of a teaching user (also referred to hereinbelow as a trainer). The trainee performs the motor skill, and his/her performance is tracked by sensors, e.g. by a video camera. The performance is processed, and then feedback of the performed motor skill is provided to the trainee. If the motor skill comprises an atomic move only, in some known solutions the system provides feedback to the trainee by reporting a set of measurements relating to the move performed by the trainee. Consider the example of a user performing a kick of a ball move. Known learning systems include providing feedback to the trainee on the specific move of the kick, with reference to the force or speed of kicking the ball, as measured by sensors on the user or the ball. In an example of a tennis player hitting a ball with a racquet, the learning system may include feedback which may relate to the angle of the hand holding the racquet.

However, while processing an atomic trainee move with reference to a trainer move can facilitate learning the specific move of the trainer, it is advantageous, according to certain embodiments of the presently disclosed subject matter, to provide a method that facilitates learning of motor skills that include a series of moves, in a personalized and automatic manner. According to certain embodiments of the presently disclosed subject matter, the motor skill can be divided, in a pre-processing stage, into individual, reusable, moves. In some examples, a move may include an atomic unit, e.g. a smallest learning unit of a dance that the user learns. A “reusable” move can include a move that can be used or repeated in more than one dance of one or more trainers. In some examples, the learning system 100 can be associated with a database, e.g. stored in memory 220 including a library of stored moves. The moves in the library can appear in one or more dances. A learning process of a move including analysis of trainee's moves when learning the move, and the feedbacks that can be associated with performance of the move, can be stored in the library, and can be used in more than one dance, e.g. by retrieving the move and the learning data associated with the move, e.g. by learning system 100. For example, a move of a “left kick” or a “kick with left leg forward at knee height” may be present in more than one dance. In some examples, splitting a dance may include not only dividing the trainer video to individual moves, but also selecting certain, differentiable moves from a library of reusable moves. Hence, the motor skill can be divided, in a pre-processing stage, into segments, where a segment can include, one move, a small, limited, number of moves, or a set of consecutive moves. In such a manner, the motor skill can be learnt in stages. For example, in the first stage, each segment can be taught separately. Then, two segments can be combined, etc.

Therefore, in some cases, the motor skill can be divided into segments, where each segment comprises one or more moves of the motor skill. The trainee can learn each segment separately, and can receive feedback on each performed segment, thus optimizing the learning of the entire motor skill and achieving better performance of the motor skill. In some examples, the motor skill can be divided into segments in a hierarchical manner, such that the trainee can learn first shorter segments, including a small number of moves, and then proceed to longer segments including a larger number of moves, and, optionally, moves that were included in the shorter segments may now be combined with new moves.

In addition, according to certain embodiments of the presently disclosed subject matter, it is advantageous to further focus on the differences in aspects of the performance of the move, e.g. the accuracy, the timing, and the style aspects of the performed move when compared to the trainer move. Learning how to mimic the trainer can be enhanced by providing relevant feedback to the trainee regarding the aspects of the performance, e.g. for each segment separately, in an automatic manner. For instance, two different trainee users might do the same move (e.g. ball dribbling or playing the guitar) in an accurate and similar manner when compared to a trainer move, yet with different style. Hence, each trainee should receive different feedback. While both feedbacks may include an indication of the high similarity to the trainer move, each feedback should focus on other aspects of the performed move, such as the style of the move. Hence, it is advantageous to process the trainee movement with respect to various aspects, such as accuracy, timing and style, and to provide feedback based on the aspects of the performance, such that feedback facilitates the trainee to improve the performance of a future move with respect to the trainer move.

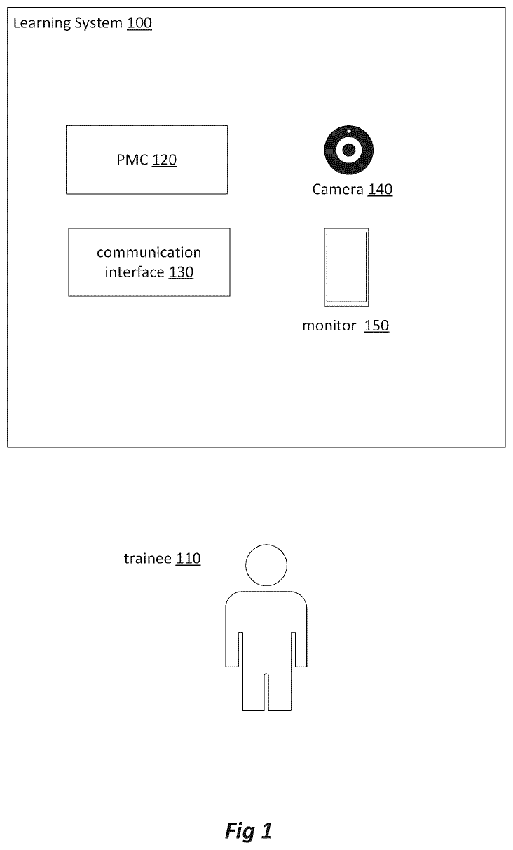

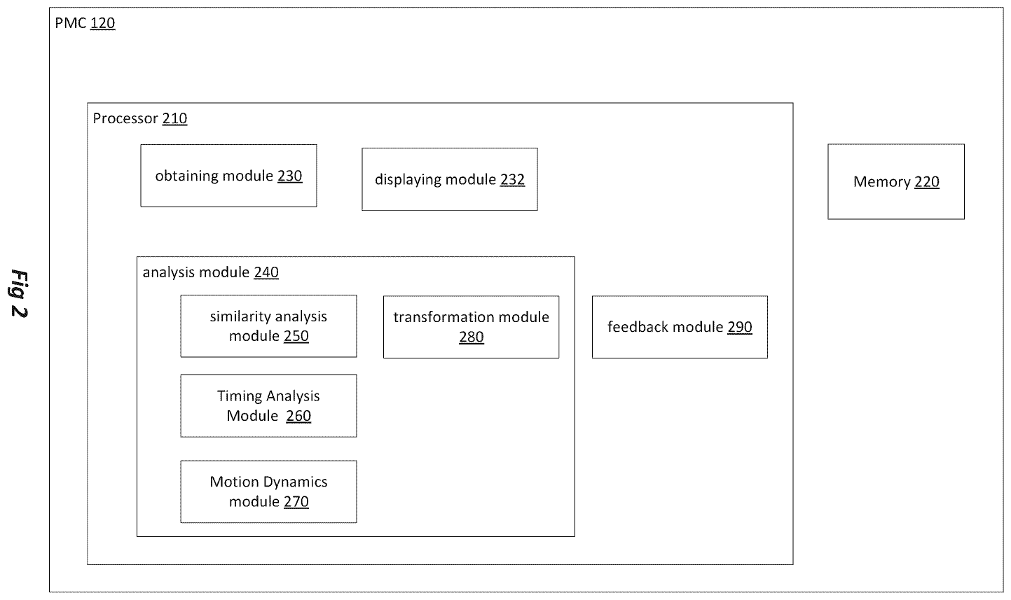

Reference is made to FIG. 1 illustrating an environment comprising a learning system 100, in accordance with certain embodiments of the presently disclosed subject matter. In some examples, learning system 100 is configured to implement a computerized method for facilitating personalized learning experience of a trainee of motor skills of a trainer. Reference is made to the definition of a motor skill in Wikipedia [https://en.wikipedia.org/wiki/Motor_skill] to include learned ability to cause a predetermined movement outcome with maximum certainty. According to the presently disclosed subject matter, the term should be used without restriction to any age or other factor. In relation to motor skills, performance may be defined as the act of executing a motor skill. In some examples, the motor skills may comprise a purposefully selected move or a series of moves, such as a dance. Hereinbelow, for purpose of illustration only, the description is provided for a dance, where the dance includes a series of moves. Those skilled in the art will readily appreciate that the teachings of the presently disclosed subject matter are, likewise, applicable to other motor skills, such as yoga, fitness, boxing, or different katal.

In some examples, the learning system 100 comprises a processor and memory circuitry (PMC) 120 comprising a processor and a memory (not shown), communication interface 130, a camera 140 operatively communicating with the PMC 120 and a monitor 150. In some examples, the learning system 100 is configured to implement a computerized method in a trainee's mobile device, while the camera 140 can be the mobile device's camera and the monitor 150 can be the screen of the mobile device. The learning system 100 is configured to facilitate learning of motor skills of a trainee 110, in a personalized and automatic manner.

According to certain embodiments of the presently disclosed subject matter, trainee 110 tries to learn a trainer's motor skill including an atomic move or series of moves by mimicking the trainer's moves. In some examples, the learning process can include several phases. A Presentation Phase may include a presentation of the trainer's moves, e.g. by presenting to the trainee a video of the trainer with execution of a motor skill. In some examples, execution of the motor skill includes execution of the correct moves of the motor skill, however, execution may include presentation of one or more common mistakes as well.

The learning process can also include a Learning Phase. The learning phase may include a phase where the trainee is prompted (implicitly or explicitly) to perform the motor skill including the moves, as shown in the trainer video. The trainee's moves are tracked by the learning system 100, analysed, and the trainee is then provided with feedback on his performance.

In some examples, the Learning Phase can include a journey flow. The journey flow may include a plurality of selectable items (referred to also as segments of the motor skill), that can be displayed to the trainee, where one item can be the entire dance, and each other item can include a portion of the dance, e.g. a move or several moves of the dance. The trainee can learn the dance by selecting, in a repetitive manner, portions of the dance to learn, as included in the plurality of displayed items. In some examples, the items to be displayed can be automatically selected by learning system 100. The journey flow is created individually for each trainee, based on the order that the items are selected. The journey flow is further described below.

It should be noted that although the presentation phase and the learning phase are described separately and sequentially, this should not be considered as limiting, and those versed in the art would realise that the phases can be executed in a reversed order, or alternately.

Referring to FIG. 2, there is illustrated a high-level functional block diagram of PMC 120 included in learning system 100 of FIG. 1, in accordance with certain embodiments of the presently disclosed subject matter. PMC 120 comprises a processor 210 and a memory 220. The processor 210 is configured to execute several functional modules in accordance with computer-readable instructions implemented on a non-transitory computer-readable storage medium. Such functional modules are referred to hereinafter as comprised in the processor 210. The processor 210 can comprise obtaining module 230, displaying module 232, analysis module 240 comprising similarity module 250, timing module 260, motion dynamics module 270, transformation module 280, and feedback module 290.

In order to execute the learning process, by starting from the presentation phase, in some cases a trainer video may be obtained by obtaining module 230, e.g. by retrieving the trainer video from memory 220 operatively communicating with PMC 120. The trainer video may be displayed on monitor 150 appearing in FIG. 1. The trainer video includes a trainer's motor skill. The trainer's motor skill can include one atomic move, or a plurality of consecutive moves. For example, the trainer's video can comprise the entire dance performed by the trainer. In some examples, the trainer video can be divided into a plurality of selectable segments. The segments can be displayed on the trainee's device, e.g. on monitor 150, e.g. by displaying module 232. Each selectable segment can include at least one move of the plurality of consecutive moves of the motor skill.

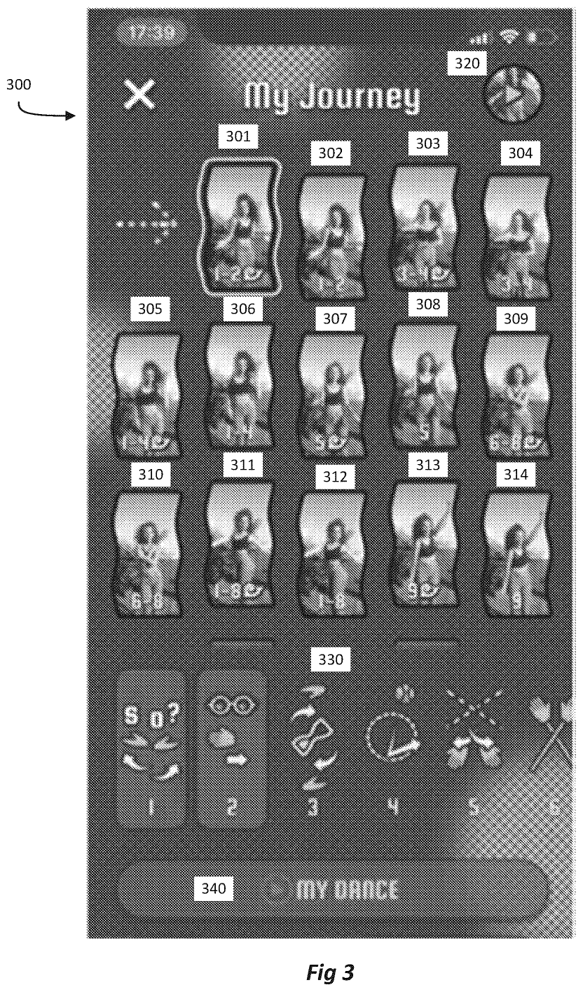

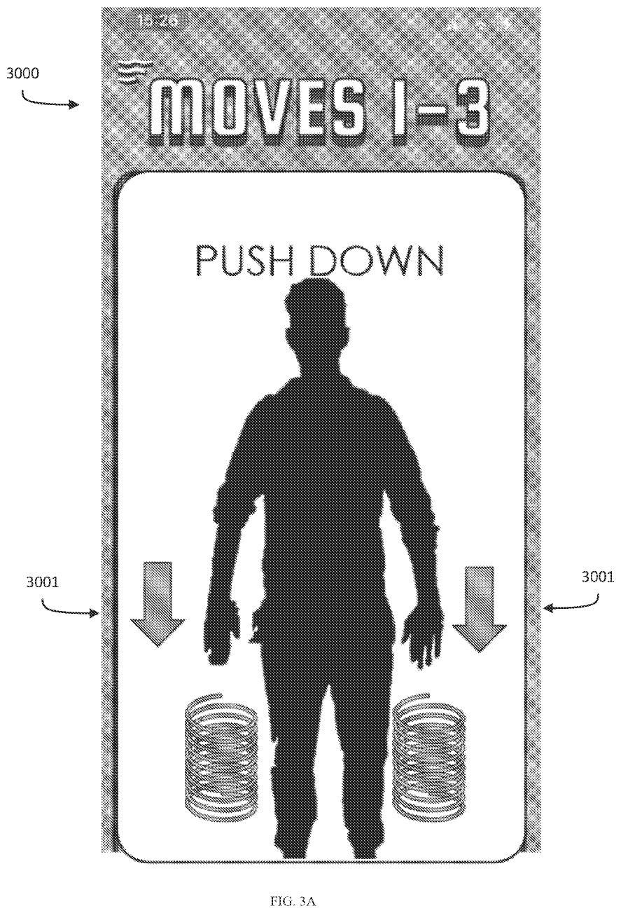

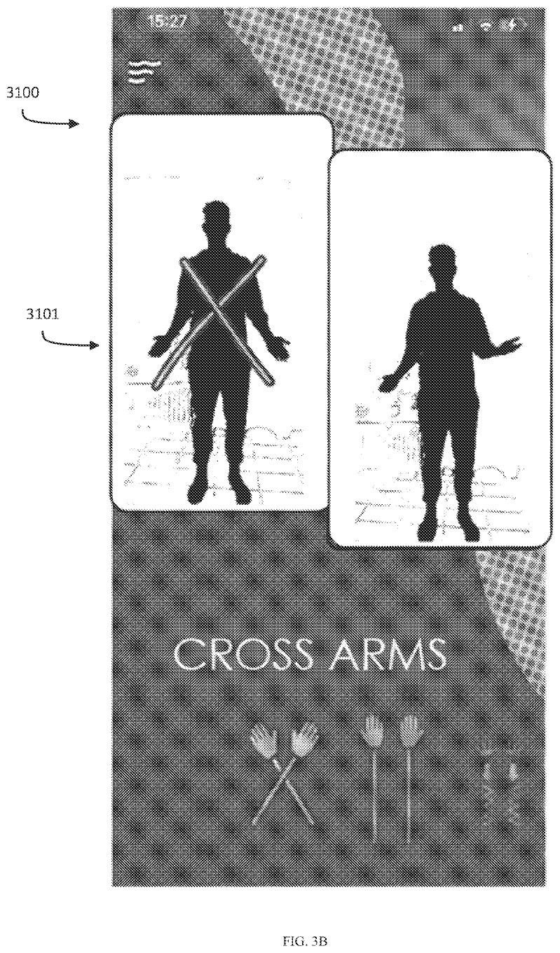

Reference is made to FIG. 3 illustrating an exemplary screenshot 300 of an exemplary motor skill of a dance type performed by a dancer. The dance is taught by a trainer's video, the dancer video. The dance includes a plurality of consecutive moves 1-9. Hence, the trainer video is divided into a plurality of segments 301-314, where each segment includes at least one move of the 1-9 moves of the motor skill. Screenshot 300 includes a menu displaying the plurality of selectable segments 301-314, e.g. as divided in the in the pre-processing stage. For example, segment includes moves 1-2, segment 308 includes move 5 and segment 312 includes moves 1-8. The segments are displayed on the user interface (screenshot 300) and can form links to trainer video with the indicated moves, such that each segment can be selected by the trainee, e.g. by pressing the link of the segment. Once the user selects a segment, the segment including the trainee video with the respective segment moves can be displayed. In some examples, the same move of the plurality of moves can be included in more than one segment, such that two different segments include at least one overlapping move. For example, moves 1-2 are included in segments 302 and 306. In some examples, at least one selectable segment 301-314 includes at least one manipulated form of a move of moves 1-9, e.g. to ease the learning process. For example, segment 307 includes a manipulated form of move 5 in slow-motion, e.g. half speed, one third speed of the portion of the trainer video in which move 5 is performed. Providing a trainer video 320 divided into segments 301-314 further comprises providing an indication of the manipulation. As exemplified, the displayed segment 307 also includes an indication of the manipulation, in the form of displaying a snail near the move number, indicating that manipulation of the move was slow speed display of the move. In some examples, at least two different segments, first and second segments of the selectable segments, include a move and a manipulated form of the move, respectively. For example, selectable segment 308 and selectable segment 307 includes move 5 and its manipulation. It should be noted that the slow-motion manipulation should not be considered as limiting, and additional examples of manipulations and respective indications are applicable. For example, a segment can include a trainer performing common mistakes in performing a move (for example, in a move of raising the right hand up, the trainer can perform the mistake of the move, by performing raising the left hand up instead.

Another example of a manipulation on a move can include a trainer video incorporating a visual overlay. A visual overlay can be incorporated in either or both a trainer or a trainee video (usage of the visual overlay on the trainee video may also be part of the feedback provided to the trainee, and is further referred to below as visual cues). The visual overlay can be displayed alongside the videos and/or over one or more of the videos, e.g. by superimposing it on the trainer's or the trainee's videos. The visual overlay can include one or more visual guiding symbols highlighting portions of a move, such as circles, directional arrows, springs, waves, balls, lightning, and others. In some examples, the semantics of the visual guidance are related to the semantics of the move, such that the visual guidance may highlight one or more notable characteristics in the body pose or the move (for example, the water animation may “flow” in the direction to which the trainee should move his arm) or an easy association to the move (like a turning hourglass used for the “flip hands” move). For example, the visual guidance may be displayed as a visual overlay, simultaneously to the trainer's move, optionally corresponding to the characteristic in the body pose that the visual guidance intends to highlight or note to the user. For example, visual guidance of sticks crossing can be associated and displayed next to arms that should be crossed in a body pose, or visual guidance of springs being pushed down can be associated and displayed next to arms that should be pushing down in a body pose. Alternatively or additionally, a screenshot of the trainer's video, including the body pose associated with the visual guidance, together with the visual guidance, can be displayed to the trainee. Reference is made to FIG. 3A for illustrating an exemplary screenshot 3000 of a trainer's video with visual guidance 3001 of down arrows. It should be noted that several figures include examples of screen shots of the application. In order to retain privacy, the figures were replaced with silhouettes, however this should not be considered as limiting.

In some examples, one or more frames from the trainer's video can be selected e.g. by learning system 100 to include body poses that should be associated with one or more visual guidance steps. Next, the body poses can be associated with visual guidance, and a corresponding visual overlay can be added to the trainer's video in the respective segment that the body poses appear. In some examples, a visual guidance is shown at least for one move. In some examples, a visual guidance is shown for more than one or every move in a dance, or in a segment of dance. Yet, in some examples, the visual guidance is shown on the trainer's video during the presentation phase, where the entire segment or dance is shown to the trainee.

In some examples, the visual guidance can be added in real time, and can also be shown on the trainee's video e.g. during the learning phase. In order to show visual guidance, it is required to detect the location of joints in order to associate these body parts with one or more visual guidance. For example, according to the location of the joint of the trainer in the video, the visual guidance on the trainee video will be added over or in a position defined relative to the coordinates of the corresponding joint of the trainee. The visual guidance may be added over virtual joints too that are created via interpolation between known joints from the computer vision model. Interpolation is done with a low-degree spline taking the anatomic prior knowledge into account, for example, the shoulder-line is perpendicular to the outline of the side of the body. In some examples, the best approximation for objects that are only partially rigid (such as the body) is achieved. In many practical scenarios linear interpolation would also yield adequate solutions and can be used, due to its advantages in consuming less resources, thus may be preferred on low-end edge devices. Reference is made to FIG. 3B for illustrating a screenshot 3100 of a trainee's video, illustrating a visual guidance 3101 on the trainee's video, where the direction of the hands is illustrated by arrows. In some examples, the visual guidance can be added to the trainee video based on the time that the visual guidance was added in the trainer's video.

Reference is made back to FIG. 3. In some examples, a segment can be associated with a segment duration (not shown in FIG. 3). The segment duration can be the duration of the portion of the trainer video in which the trainer performs the moves of the segment. For example, the segment duration of segment 308 including move 308 can be the duration of performing move 308 by the trainer in the trainer video. Different selectable segments can be associated with different segment durations. For example, the segment duration of segment 307, including move 5 in a slow-motion manipulation, is expected to be longer than the segment duration of segment 208 including move 5 in its original form. In some examples, a segment is an aggregated segment forming an aggregation of at least two other selectable segments. For example, segments 302 and 304 includes moves 1-2 and 3-4, respectively, and segment 311 is an aggregation of segments 302 and 304 and includes all the moves 1-4 appearing in the previous segments. An aggregated segment can also aggregate moves from a previous segment with a new move from the moves of the motor skill. The aggregated segment may have a longer duration than the duration of the segments that it aggregates. Providing aggregated segments to the trainee enables the trainee to first learn shorter segments including a few moves, and then, upon success in performing the shorter segments, to proceed to longer segments having a larger number of moves. Learning the motor skill by learning various segments, and receiving feedback for each segment, where the segments have a different number of moves, and some of the segments aggregate moves appearing in other segments, facilitates the trainee to improve the performance of the motor skill with respect to the trainer's motor skill.

In some examples, the trainer video is divided into a hierarchy of the plurality of selectable segments, the segments representing a hierarchical learning flow with levels of hierarchy. A segment at a low level of the hierarchy can include one move, or a small number of moves. A segment at a higher level of the hierarchy can include (i) all the moves included in at least one lower level selectable segment of the hierarchy and, (ii) at least one move of the plurality of consecutive moves that is not included in the at least one lower level selectable segment of the hierarchy. The hierarchy may continue upward indefinitely. The hierarchy may correspond to a post-order method of depth-first traversal of a binary tree in computer science. Dividing the motor skill and executing the learning phase, while tracking the hierarchy in the journey menu may be advantageous, as it may ease the learning of the dance and result in faster and more efficient learning of the dance, and a high performance score of the trainee. It should be noted that the hierarchy may include an optional optimal executing of the learning phase, that will result in more efficient learning of the dance. As illustrated in FIG. 3, the screenshot 300 shows the segments in an exemplary hierarchical learning flow from left to right, and from top to bottom. As illustrated, from left to right and from top to bottom, segment 301 includes a slow-motion form of the moves 1-2, followed by a normal speed version of moves 1-2 in segment 302. The same division and manipulation are applied for segments 303 and 304. The segments learned first are usually short segments and early moves in the dance to learn, such as moves 1-2, or moves 3-4. On one level up, on the second row, there are longer segments, including moves 1-4 in segments 305 and 306, and later additional moves 6-8 in segment 309. One additional level up on the third row, there are included even longer segments 311 and 312 including moves 1-8, which are also the later moves in the dance, and optionally include all moves in the dance.

Reference is made back to FIG. 2 and PMC 120. Once a segment is displayed, the trainee performs the moves. A video of the trainee can be captured by a camera 140 and can be obtained by obtaining module 230. The trainee video is then analyzed by analysis module 240, optionally with the assistance, of similarity analysis module 250, timing analysis module 260, Motion Dynamics module 270, and transformation module 280, to obtain a segment performance score. An analysis of the trainee's video is further described below. Based on the segment performance score, feedback module 290 is configured to generate and provide feedback to the trainee. The feedback can be displayed on monitor 150, e.g. by displaying module 232.

It is noted that the teachings of the presently disclosed subject matter are not bound by the learning system described with reference to FIGS. 1 and 2. Equivalent and/or modified functionality can be consolidated or divided in another manner, and can be implemented in any appropriate combination of software with firmware and/or hardware, and executed on a suitable device. The learning system 100 can be a standalone network entity, or integrated, fully or partly, with other network entities. Components of the learning system 100, such as PMC 120, camera 140 monitor 150, can be integrated as components of a mobile device comprising the learning system 100, or can be separated, and operatively communicate with PMC 120 e.g. through a communication interface 130. Those skilled in the art will also readily appreciate that the data repositories, such as memory 220, can be consolidated or divided in other manner; databases can be shared with other systems, or be provided by other systems, including third party equipment.

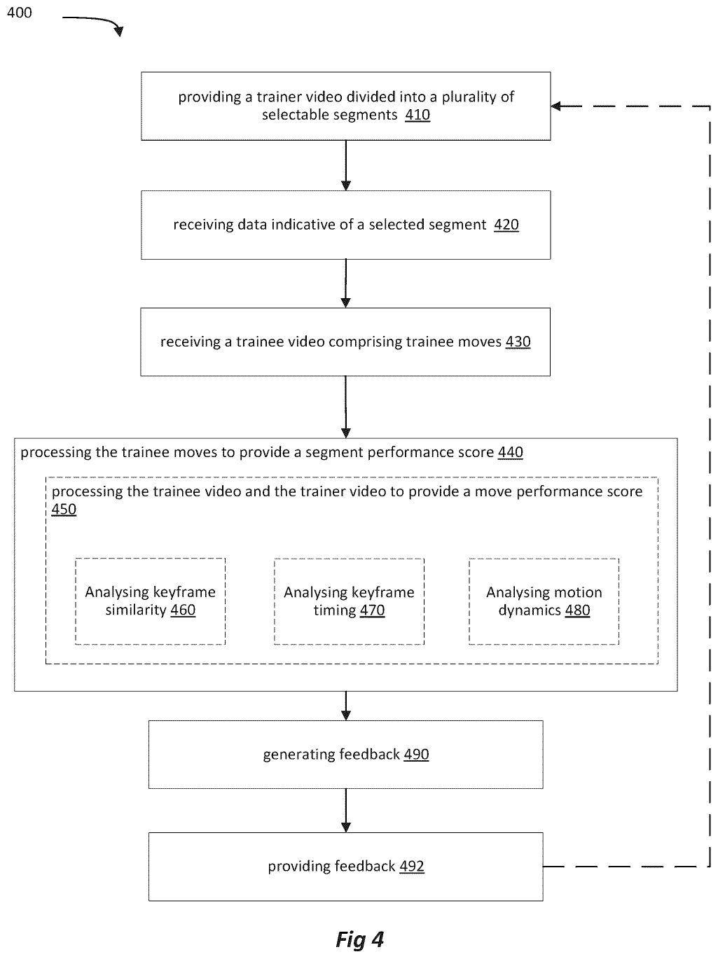

Referring to FIG. 4, there is illustrated a generalized flow chart of operations performed by PMC 120, in accordance with certain embodiments of the presently disclosed subject matter. The operations are described with reference to elements of learning system 100 and PMC 120. However, this is by no means binding, and the operations can be performed by elements other than those described herein. It should also be noted that the stages of FIG. 4 are illustrated as performed by a computer server comprising a PMC 120, which is configured to implement the stages of FIG. 4, by communicating and transmitting data with a trainee device. However, those skilled in the art will appreciate that the conception upon which this disclosure is based may readily be utilized as a basis for designing other structures, methods, and systems for carrying out the stages of FIG. 4. As such, the stages can entirely or partially be implemented on a trainee's device, at a client side, mutatis mutandis.

Turning to FIG. 4, obtaining module 230 can provide a trainer video divided into a plurality of selectable segments (block 410). For example, the trainer video can be provided by retrieving the trainer video from memory 220 operatively communicating with PMC 120 and providing the trainer video to be displayed on monitor 150 appearing in FIG. 1. As mentioned above, the trainer video includes a trainer's motor skill. The trainer's motor skill can include one atomic move, or a plurality of consecutive moves. For example, the trainer's video can comprise the entire dance performed by the trainer. In some examples, the trainer video can be divided into a plurality of selectable segments. The segments can be displayed on the trainee's device, e.g. on monitor 150, e.g. by displaying module 232. Each selectable segment can include at least one move of the plurality of consecutive moves of the motor skill. Those skilled in the art would appreciate that in some examples, the trainer video can be displayed in one segment only including one or more moves. In such cases, the remaining selectable segments of the plurality of segments, as referred to herein and below, can refer to empty segments including no moves. In such cases, the screenshot of FIG. 3 can display only one selectable segment.

In some examples, once the presentation phase is over, learning system 100 can execute the learning phase. The learning phase can commence by the trainee selecting one of the selectable segments displayed on monitor 150. For example, the trainee can select, from the displayed segments, one of the segments to start. Alternatively or additionally, PMC 120 can automatically select a first selectable segment to display. Since, as explained, the segments may be provided in a hierarchical manner, in which the first segments are shorter and include the first moves of the motor skill, automatically selecting the first segment by PMC 120 may in itself facilitate the motor learning of a motor skill by a trainee.

Once a segment is selected, it may be displayed to the trainee on the monitor 150. In some examples, the trainee's video can be displayed together with the trainer's video. Optionally, the trainee can define e.g. via a menu, the proportion and size of each displayed video on the viewport, e.g. the size of the trainer's video, and the size of the trainee's video or camera area. Irrespective of whether the trainee selects the segment, or PMC 120 automatically selects the segment, PMC 120 receives data indicative of a selected segment displayed to the trainee (block 420). In some examples, PMC 120 can mark each segment that was selected, e.g. by highlighting the selected segment, to ease tracking of the journey and the selected segments of the individual trainee. With reference to FIG. 3, segment 301 is marked with an additional bright line.

Following display of the segment, the trainee 110 tries to mimic the trainer's move and performs the moves included in the displayed segment. In some examples, the trainee 110 performs the moves simultaneously with the display of the segment. Alternatively, the trainee 110 can watch the trainer's video and then perform the moves, optionally together with another display of the same segment.

In some examples, camera 140 captures a trainee video. PMC 120 receives the trainee video from camera 140 (block 430). In case PMC 120 operates on the trainee's device, then PMC 120, e.g. using obtaining module 320, receives the trainee video from camera 140. In case PMC 120 operates in a remote server to camera 140, PMC 120, e.g. using obtaining module 320, can receive the trainee video e.g. by communicating with camera 140 and receiving data indicative of the trainee video. The trainee video comprises at least one trainee move.

In some examples, in order to improve the analysis of the performance of the trainee's moves in the captured trainee video, and comparison to the trainer's body proportion, to facilitate providing the feedback in a more accurate manner, a process of calibration can be performed. The calibration process assists in measuring the individual's body proportions, e.g. the trainee's individual limb length. In some examples, calibration can be performed one time, e.g. at the beginning of the learning phase, and/or at the beginning of a segment. Yet, in some examples, the learning system 100 can be integrated in a mobile device, while the camera 140 can be the mobile device's camera. In such examples, during the learning, the trainee keeps moving towards the camera and back, e.g. in order to better view the feedback that is displayed on his performance of the previous segment. In order to better analyse the trainee's moves, it may be advantageous to perform calibration at the beginning of every segment. As opposed to known solutions, which require calibration, and in which the calibration phase requires an individual to stand at a specific distance in a specific pose for the camera to capture the individual, according to certain embodiments of the presently disclosed subject matter the calibration can be performed by enabling a trainee to stand freely at a selected distance from the camera. PMC 120 can provide a visual calibration shape to be displayed on the trainee's device, wherein displaying the visual calibration shape facilitates calibration of the captured trainee video with a trainee's position. For example, the calibration can include the camera capturing the surroundings of the trainee with the trainee, and displaying a visual shape, e.g. a rectangle in which the trainee should stand in relation to the shape. For example, during calibration, it may be required from the trainee to stand inside a rectangle with a specified set of joints (e.g. it can be required from the trainee that his/her upper body is inside of the rectangle, or that the trainee's full body is inside the rectangle). Enabling calibration, where the trainee stands freely, gives the trainee flexibility, while it guarantees that analysis of the trainee moves, as captured by the camera, are optimally processed on the visible trainee's joints.

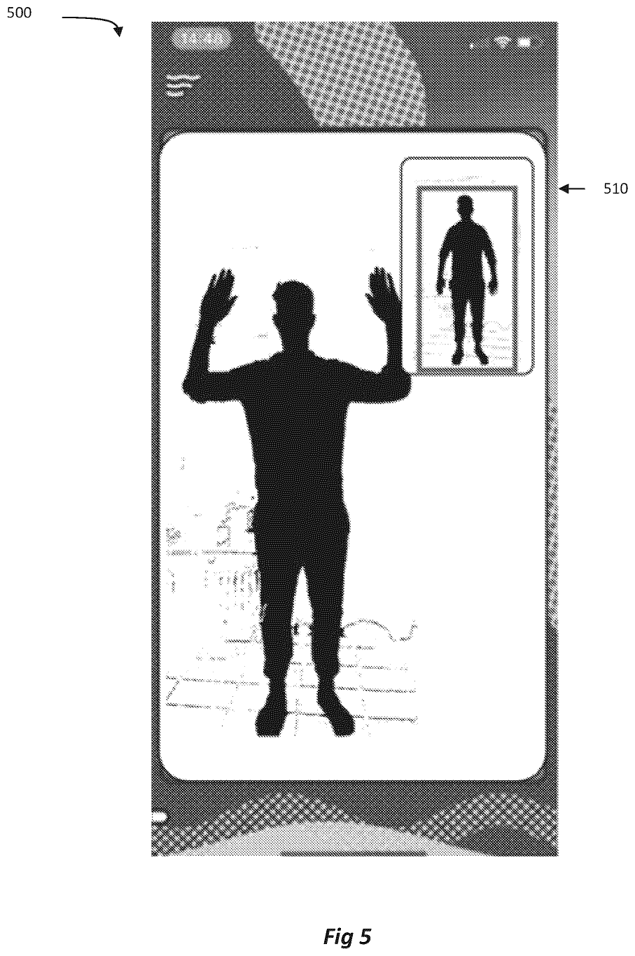

In some examples, once the trainee performs the moves, the body pose of the trainee may be processed in conjunction with the rectangle shown, to notify the trainee in case the position needs to be changed, e.g. if the trainee is too close, too far away, or outside of the rectangle. The trainee can be notified so that the trainee can correct his/her position. Reference is made to FIG. 5 illustrating an example of a screenshot 500 in which the monitor 150 displays an area 510 in which the camera captures the trainee, and displays the trainee with a rectangle indicating an area that the trainee should stand in.

Once the trainee video is obtained, PMC 120, e.g. using analysis module 240, processes the at least one trainee move in the trainee video with respect to at least one corresponding move of the trainer, as included in the selected segment, to obtain a segment performance score (block 440). The segment performance score is indicative of a performance of the at least one trainee move in relation to the at least one corresponding move of the selected segment.

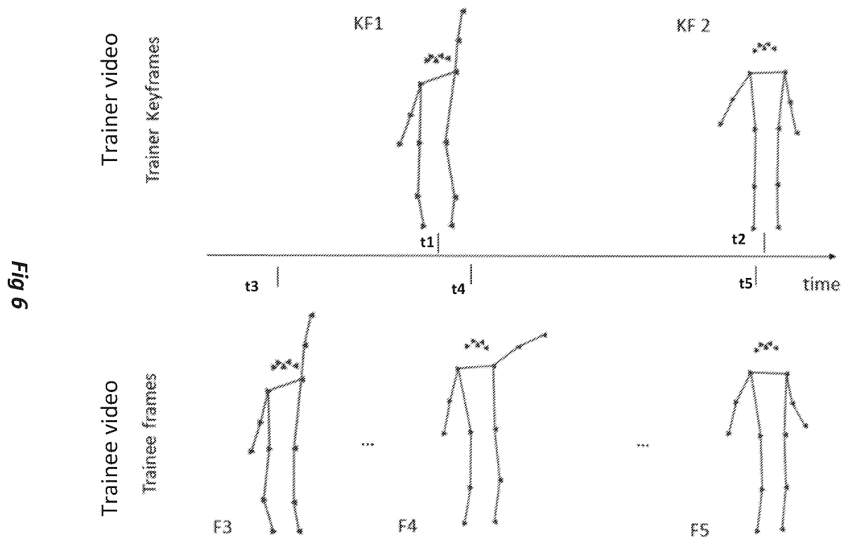

In some examples, processing the trainee moves to provide a segment performance score can be done by processing the trainee video and the trainer video to provide a move performance score (block 450). A move performance score is indicative of the performance of one trainee move of the at least one trainee move in relation to one trainer move of the plurality of consecutive moves. The processing is done with respect to at least one aspect of the performance, e.g. by performing one or more of analysing keyframe similarity (block 460), analyzing keyframe timing (block 470) and analyzing motion dynamics (block 480). Processing the trainee video and the trainer video to provide a move performance score is further described below with respect to FIGS. 6-17.

It should be noted that the move performance score should not be confused with a segment performance score. The move performance score is indicative of the performance of a single trainee move in relation to a single trainer move of the trainee's and the trainer's moves, where the performance can be evaluated with respect to various aspects of the performance.

In cases where each selected segment includes one move only, the result of processing of the trainee move with respect to a corresponding move included in a selected segment is a move performance score, which is identical to the segment performance score. The segment performance score is indicative of a performance of the trainee move in relation to the corresponding move of the selected segment. In cases where the trainee video and the selected segment include more than one move, processing the trainee moves with respect to corresponding moves included in the selected segment results in a number of move performance scores, each calculated for one move of the trainee's moves with respect to corresponding moves in the selected segment. The number of move performance scores can be fused into a segment performance score, e.g. by aggregating them. Aggregation of the number of move performance scores can be done in a similar manner to that described with respect to fusing the scores of various aspects in block 790 of FIG. 7). The segment performance score is indicative of the performance of the trainee moves in relation to the corresponding moves of the selected segment.

Analysis module 240 comprises similarity module 250, timing module 260, and motion dynamics module 270. Each of the modules 250, 260, and 270, are configured to analyse the trainee moves with respect to at least one aspect of the performance, and to provide an aspect score. For example, similarity module 250 is configured to analyse the similarity of the trainee move to that of the trainer move, and to provide a similarity score. Timing module 260 is configured to analyse the timing of the trainee move, and to provide a timing score. Motion dynamics module 270 is configured to analyse the style of the trainee move, when considering various motion dynamic features of the trainee move, and to provide a motion dynamics score. Following is a detailed description of analysing the aspects of performance, as performed by modules 260, 270, and 280, with reference to FIGS. 6-17. For clarity, it should be mentioned that once the trainee moves are analysed and a segment performance score is obtained, feedback is generated (block 490) and is provided (block 492) to the trainee. Generating and providing the feedback are described further below.

PCT Application No. PCT/IL2021/050129 “Method of scoring a move of a user and system thereof”, filed on Feb. 3, 2021, includes some examples of analysis of the trainee's move in the trainee's video, with respect to similarity, timing and motion dynamics features, in order to provide a move performance score with respect to various aspects of the move, and is incorporated herein with its entirely. The content of PCT/IL2021/050129 is also added in the following description. However, it should be noted that other known per se methods can be used to process the trainee's moves with respect to the trainer's moves in order to provide a segment performance score.

Reference is now made to FIG. 6 illustrating an exemplary trainer video and a trainee video, in accordance with certain embodiments of the presently disclosed subject matter. It should be noted that for purpose of illustration only, the following description is provided for processing a video of a trainee or a trainer, e.g. a trainee video as captured by a camera. Those skilled in the art will readily appreciate that the teachings of the presently disclosed subject matter are, likewise, applicable to any other medium that is configured to provide data on a move of a user. The move of the user may include a detected sequence of poses of a user. Each pose may be defined by a set of joints. A frame input may include one pose defined by the set of joints. The frame input can be derived from a video, a sequence of images, recording of marker-based pose sequences (mocap/motion capture), digital animation data, complex motion sensing device (e.g. Kinect), etc. which can be obtained from various sensors including motion capture, depth camera (time-of-flight imaging), IMU-based pose-tracking systems and others.

In some examples, each of the trainer and trainee videos includes at least one move. For example, the trainer video may include a trainer move of putting the hand down. In some cases, in order to provide a move performance score for a trainee move, it may be advantageous to divide the trainer move, and the trainee move, into frame and keyframes. A frame, as known in the art, may include a shot in a video, with 2D or 3D representation of the skeleton of a person appearing in the shot, or other vector-based representation of a person, at a particular point in time of the video. A move of the person can be represented by a sequence of frames. In examples where a sequence of trainee images are received (instead of a trainee video), each image can be referred to as a frame. A keyframe should be expansively construed to cover any kind of a subset of a sequence of frames, typically defining a starting or ending point of a transition in a move. In some examples, keyframes can distinguish one frame sequence from another, and can be used to summarize the frame sequence, such that it is indicative of the move of the person in the sequence of frames.

As illustrated in FIG. 6, for example, the trainer move of putting the hand down may be represented by a sequence of frames (not shown) and may include two keyframes taken from the sequence of frames. The first keyframe KF1 is when the hand is up, and the second keyframe KF2 is when the hand is down. Determining keyframes from a sequence of frames can be done e.g. manually, or by executing known per se techniques on the trainee video. Times t1 and t2 indicate the time in the video during which KF 1 and KF 2 appeared. The trainee move is represented by a sequence of three frames. F3, F 4 and F5. Times t3-t5 indicate the time in the video during which F3-F5 appeared. As explained further below, processing frames in a trainee move to keyframes in a trainer move may assist in evaluating the performance of the trainee move in a more accurate manner. Once a trainer move is divided into keyframes, for each trainer keyframe included in the trainer move, it is advantageous to select a matching frame from the trainee move. One approach of selecting a matching trainee frame to a trainer keyframe includes selecting trainee frames that appear at the same time, or substantially the same time, as in the trainer video. For example, trainee frame F4 appears in time t4, which is substantially the same as KF 1 in t1, and hence may be selected as a matching frame to trainer KF1. For a similar reason, F5 in time t5 may be selected as a matching frame to trainer KF2 in t2. However, selecting the matching frame in a straightforward manner may yield to selecting matching keyframes which are not optimal, e.g. from a visual comparison perspective, resulting in less accurate evaluation of the trainee move. The resulting feedback that the trainee will receive, which is based on his score, will also not assist the trainee in performing a future move in a better manner. Instead, a more accurate selection of a matching keyframe should be made. This assumes that the trainee tries to imitate and learn the move of the trainer, and hence, its initial performance of the move is not perfect, as otherwise no training would have been required. During training, the trainee may perform a move in an accurate manner, yet not at the same time as the trainer. For example, a trainee may perform the move of the trainer, but with a delay in time, in a slower rhythm than that which is performed by the trainer, or in an opposite sequence of moves than that performed by the trainer. In such cases, if an optimal selection of a matching keyframe is done, the trainee move will be evaluated and feedback will be provided with a high similarity score and a poor timing score. The trainee receiving the feedback would focus on improving the timing of the move, rather than unnecessary focus on performing the move in a more accurate manner. In FIG. 6, selection of F3 as a matching keyframe to KF1 is better and yields better feedback, while focusing on the poor timing, instead of the lack of similarity, of a move.

As explained, once a trainer and trainee's videos are obtained PMC 120, e.g. using analysis module 240, is configured to process the trainee move in the trainee video, based on the trainer move included in the trainer video, in order to provide a move performance score. Analysis module 240 comprises similarity module 250, timing module 260, and motion dynamics module 270. Each of the modules 250, 260 and 270 are configured to analyse the trainee move with respect to at least one aspect of the performance, and to provide an aspect score. For example, similarity module 250 is configured to analyse the similarity of the trainee move to that of the trainer move, and to provide a similarity score. Timing module 260 is configured to analyse the timing of the trainee move, and to provide a timing score. Motion dynamics module 270 is configured to analyse the style of the trainee move, when considering various motion dynamic features of the trainee move and to provide a motion dynamics score. Analysing the aspects of performance, as performed by modules 260, 270 and 280, is further described below with respect to FIGS. 6-17.

The calculated aspect scores can be transformed, e.g. by the transformation module 280, giving rise to a move performance score. For example, a similarity score can be calculated for each trainee frame. Transformation module 280 is configured to aggregate the similarity scores of all trainee frames into a single move performance score. In some examples, if more than one aspect scores are calculated, then the scores of each aspect for each frame can be fused, e.g. using a conditional aggregation, giving rise to the move performance score. Fusing several aspects scores is further described below with respect to FIG. 7. Based on the move performance score, feedback module 290 is configured to provide feedback to the trainee, whereby the feedback facilitates the trainee to improve the performance of a future move with respect to the trainer move.

Referring to FIG. 7, there is illustrated a generalized flow chart of operations performed by PMC 120, in accordance with certain embodiments of the presently disclosed subject matter. The operations are described with reference to elements of learning system 100 and PMC 120. However, this is by no means binding, and the operations can be performed by elements other than those described herein.

The performance of move of a trainee in an input frame, e.g. a trainee video or a sequence of images, can be processed and scored in relation to a trainer move in a trainer video. As explained above, in order to process the trainee move in a more accurate manner, it may be advantageous to process frames included in the move. In some examples, the obtained trainer video includes two or more trainer keyframes. The obtained trainee video comprising a trainee user move, where the trainee user move can comprise a plurality of trainee frames. As mentioned above, the description is provided for processing a video of a trainee, e.g. as captured by a camera. Those skilled in the art will readily appreciate that the teachings of the presently disclosed subject matter are, likewise, applicable to any other medium that is configured to provide a frame input, including a move of a user, such as a sequence of trainee images.

Analysis module 240 can then process the plurality of trainee frames to provide a move performance score (block 720). Block 720 correspond the stage of processing the trainee video and the trainer video to provide a move performance score (block 450 of FIG. 4). The move performance score can be indicative of the performance of the trainee move in relation to the trainer move, with respect to at least one aspect of the performance. For example, the aspects of performance can include similarity analysis, timing analysis, and motion dynamics analysis (block s 460, 470 and 480 of FIG. 4, respectively). These aspects are further described below.

Analysis module 240 can select, for a trainer keyframe, a corresponding trainee frame of the plurality trainee frames. The selected trainee frame constitutes a candidate trainee frame. In some examples, analysis module 240 can select, for a trainer keyframe, more than one corresponding trainee frames constituting candidate trainee frames. In some examples, for each trainee frame, one or more corresponding trainee frames are selected and constitute candidates. A matching trainee frame to the trainer keyframe can be selected from the candidate trainee frames.

Selection can be based on a selection criterion. For example, the selection criterion can be a time criterion. Selecting according to time criterion can include selecting one or more trainee frames that appear in a time window in the trainee video, that are around a time point of the trainer keyframe in the trainer video. The term “time window around a time point” should not be considered as limiting and should be interpreted in a broad manner. In some examples, the trainee time window includes a time interval comprising a predefined time before and/or after the time point that the trainer keyframe appears in the video.

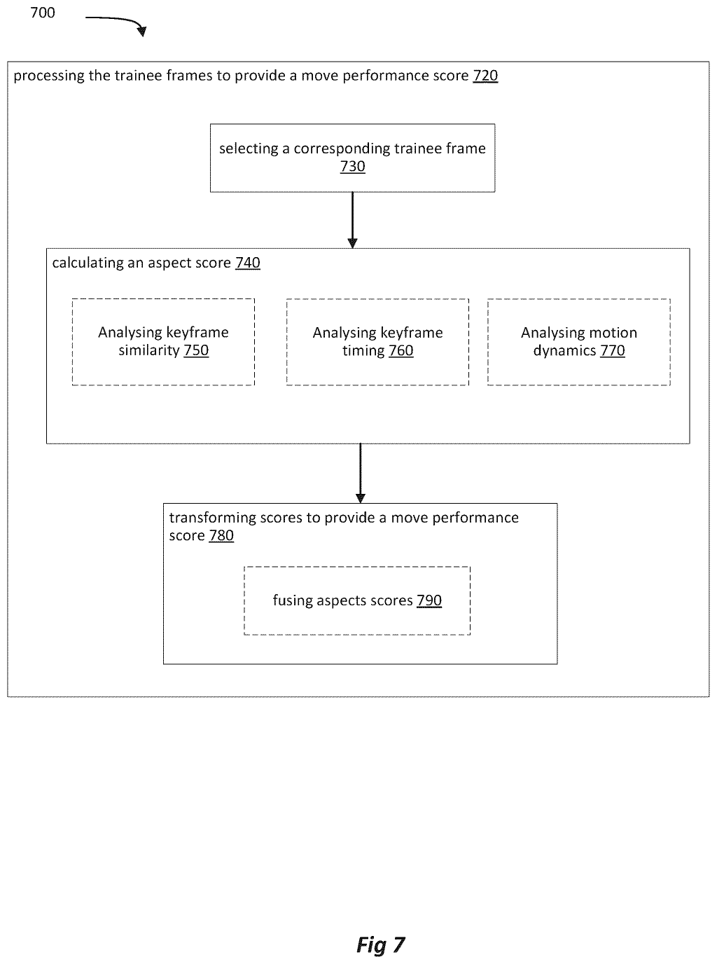

Reference is now made to FIG. 8 illustrating exemplary timelines 800 of trainer keyframes and trainee frames in respective trainer and trainee videos. As illustrated in FIG. 8, trainer move includes two keyframes KF1 and KF 2, however, this should not be considered as limiting and the trainer move can include one trainer keyframe only. In FIG. 8, KF1 appears in time point 00:03 denoted by timepoint w1, and KF2 appears in time point 00:06 denoted by time point w2. The trainee move includes eight frames, F3-F10 appearing in respective time points 00:01 to 00:08.

For each trainer keyframe KF1 and KF2, one or more trainee frames F3-F10 may be selected as candidates. For example, for trainer KF1 appearing in time point w1 a predefined+2/−2 time interval may be determined, and trainee frames F3-F7 appearing in a time window w3 that is around time window w1 can be selected as candidates. Yet, in some examples, the predefined time may be 0. In such examples, the trainee time window is identical to the trainer time point, resulting in selecting one candidate trainee frame for each trainer keyframe. The candidate appearing at the same time point in the trainee video as the trainer keyframe appears in the trainer video. For example, F5 may be selected for KF1 and F8 may be selected for KF2. It should be noted that in some examples, the trainee time window can include the entire trainee video, and the candidates for a trainer keyframe can be selected from the entire trainee video. However, selecting candidates from a time window that is shorter than the entire trainee video may optimize the process and require less computational time for processing.

Referring back to FIG. 7, in some cases, an aspect score can be calculated based on a trainer keyframe and the respective candidate trainee frames (block 740). In case the trainer move comprises more than one trainer keyframes, an aspect score can be calculated for more than one trainer keyframe and the respective candidates. With respect to the example in FIG. 8, a first aspect score can be calculated for KF1 and candidates F3-F6, while a second aspect score can be calculated for KF2 and candidate F8. If the move performance score is provided with respect to more than one aspect of the performance, then an aspect score can be calculated for each trainer keyframe and the respective candidates. For example, based on KF1, a similarity score and a timing score can be calculated for each of candidates F3-F6.

Once one or more aspect scores are calculated, the scores may be transformed to provide a move performance score (block 780) This last stage is further described below.

Following is a description of three exemplary aspects of the performance and calculating aspect scores for each of them as described in block 740 in FIG. 7. The aspects are a similarity aspect, a timing aspect, and a motion dynamics aspect. Analysis based on these aspects correspond the analysis in block s 460, 470 and 480 in FIG. 4. It should be noted that each aspect is independent of the other one. Yet, one aspect score can be calculated and be provided as an input, and be used in the calculation of a score of another aspect. For example, scores can be calculated for similarity and motion dynamic aspects, and can be provided as an input when calculating a timing aspect score.

The similarity aspect may measure to which extent the trainee move is similar and accurate, with respect to the trainer move. In some examples, in order to evaluate similarity of moves, body parts in a trainer keyframe can be compared to body parts in the candidate trainee frame. Body parts in a pose can be defined by joint pairs, e.g. by their start and end joints, where a joint may be regarded, as known in computer vision terminology, as a structure in the human body, typically, but not exclusively, at which two parts of the skeleton are fitted together.

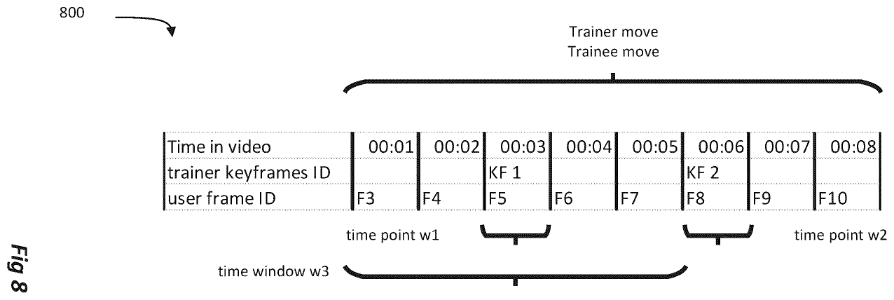

In order to calculate the similarity aspect score, the angular differences between body parts in a pose of the trainer in the trainer keyframe, and body parts in a pose of the trainee in the candidate trainee frames, can be computed. Reference is now made to FIG. 9 illustrating an example of computing one angular difference between body parts in a keyframe and a frame. A more general description of the process follows the description of FIG. 9. Illustrated in FIG. 9 are poses A and B shown from a trainer keyframe and a trainee frame, where only the torso and the left arms of each pose A and B are illustrated. Pose B is illustrated in a dashed line. In this example, a body part, such as the lower arm, is defined by a vector representing a joint pair. Lower arm C of body pose A is defined by a vector from the elbow joint j1 to the wrist joint j2 and lower arm D of body pose B is defined by a vector from the elbow joint j1, (identical to j2 of body pose A) to the wrist joint j3. The similarity of the two vectors of lower arms C and D can be compared, e.g. by using an angle E of the two vectors and the cosine distance. Other body parts in the pose can be represented by other vectors, and a similarity calculation can be performed for the other vectors. Based on calculated similarity of several body parts of the pose, a similarity score can be determined, e.g. by aggregating the similarity of the separate body parts.

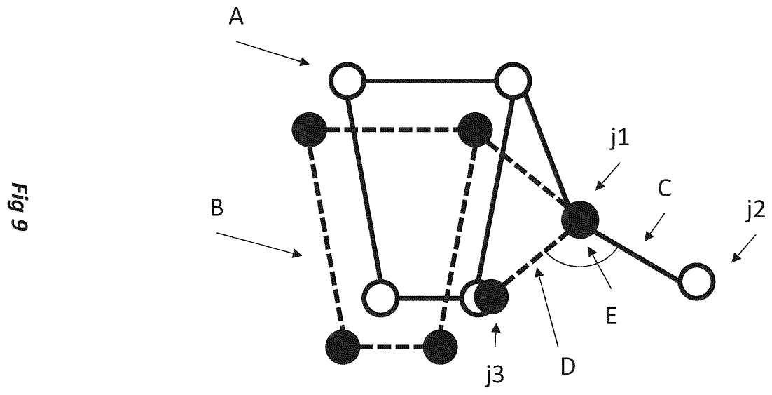

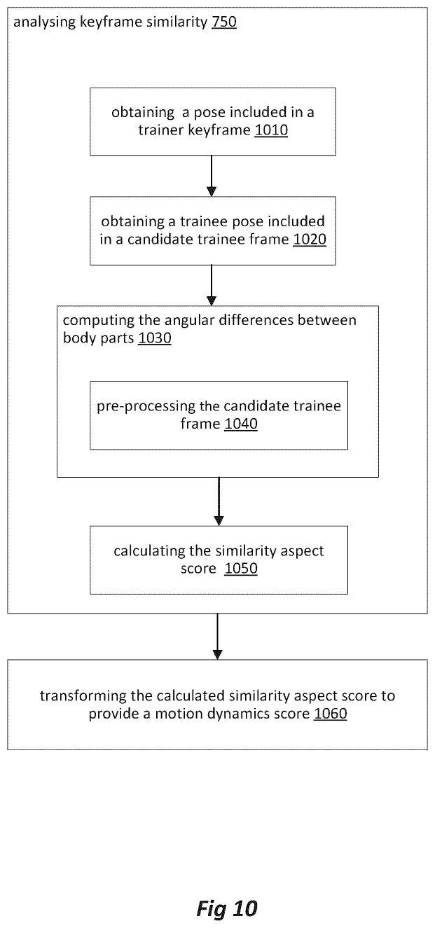

Referring now to FIG. 10, there is illustrated a generalized flow chart of analysing keyframe similarity 350 comprised in calculating an aspect score 740 block in FIG. 7, in accordance with certain embodiments of the presently disclosed subject matter. The stages can be performed e.g. by similarity analysis module 250 appearing in FIG. 2.

A trainer keyframe can include a pose. A trainer pose can be obtained (block 1010), e.g. by defining a set of several body parts appearing in the trainer keyframe. Each body part may be represented by a vector from the start joint to the end joint. A trainee pose from a candidate trainee frame can be obtained, e.g. using known, per se techniques, (block 1020), for example, by defining a set of several body parts appearing in the candidate trainee frame. Each body part may be represented by a vector from the start joint to the end joint and may correspond to a respective body part in the trainer pose, starting from the same start joint to the end joint. This enables comparison between the vectors. In FIG. 9, the comparison is illustrated by plotting the two poses on top of each other (yet, the plotting is not a necessary operation) to visualize how the lower arm of the trainee is compared the lower arm of the trainer.

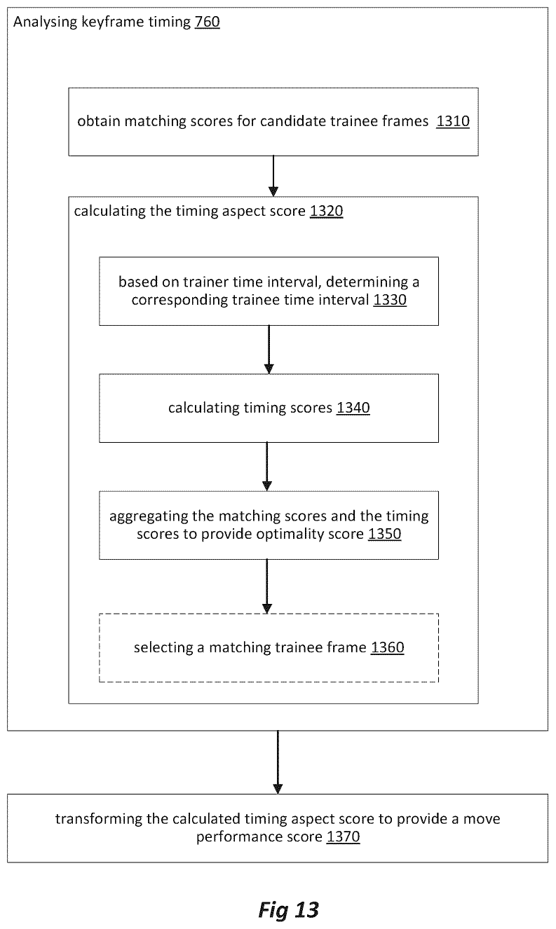

For at least one body part included in the trainer keyframe, and at least one corresponding body part included in the candidate trainee frames, analysis module 250 can compute the angular difference between the body parts (block 1030). For example, analysis module 250 can compute the angular difference between the vectors of the body parts, e.g. as illustrated in FIG. 13, using angle E between body part C and D. In some examples, the difference between two vectors can be calculated based on appropriate distance metrics, by computing at least one parameter from a group of parameters comprising: absolute angular difference, cosine distance, and a learned distance. With respect to learned distance, in some examples, the distance metric between two vectors can also be learnt from data. For example, mapping from differences of two vectors to a distance is learned based on examples with known (or annotated) distance. Learning methods can include regression, neural networks, or statistical approaches.

In some examples, using angular differences, such as angle E illustrated in FIG. 13, may be advantageous, since the body skeletons in poses in the keyframes or frames are not required to be normalized to unit height. Yet, in some examples, the trainer keyframe is associated with a predefined keyframe format, e.g. normalized to unit height, or includes dimensional information which assists in formulating the vector of the body parts. In such examples, before computing the angular differences, analysis module 250 can pre-process the candidate trainee frames in accordance with the predefined keyframe format of the trainer keyframe, giving rise to a formatted candidate frame that is formatted according to the predefined format (block 1040). The angular differences can then be computed between the body parts in the trainer keyframe and body parts in the formatted candidate frames. For example, the trainer body parts in poses in the trainer keyframe can be normalized into unit height. Hence, before conducting the similarity calculation, the trainee frame can be pre-processed by normalizing the trainee body parts to unit height. Normalization can be based on either a set of standard human relative body part lengths, or on a calibration phase to the trainee relative body part lengths.

Another example of pre-processing relates to the dimension of the vector representing body parts. Based on information captured by a non-depth camera, a 2-dimensional vector of body parts can be formulated. In some examples, a depth plane extension can be predicted from the 2-dimensional information, to formulate a 3 dimensions vector representing the body parts. For example, this can be done using the principle of projection: the projection of a line segment with a known length appears shorter when the start and end point are not located on the same depth. Representing a body part as a 3 dimensions vector may be advantageous as computing the angular differences between the body parts is more accurate since it accounts for rotation in the depth plane as well.

Based on the computed angular differences, analysis module 250 can calculate a similarity aspect score for a frame (block 1050, which corresponds to block s 740 and 750 in FIG. 7), e.g. by aggregating the angular differences of the separate body parts.

In some examples, the aggregation can be weighted and indicate a predefined importance of the body parts in the pose, such that the computed angular differences between less important body parts will contribute less to the calculation of the similarity aspect score. In order to indicate a predefined importance of body parts in a pose, a body part of the trainer can be associated with a respective weight. The weight can be indicative of the importance of the body part in the pose. In the example of putting the hand down, low weights may be associated with legs body parts, average weights may be given to the hand which is not moving, and high weights may be associated with body parts of the hand which should be put down. One or more body parts may be associated with a zero weight, such that they do not contribute to the similarity aspect score. The associated weights can be stored, e.g. in memory 220, and can be retrieved by analysis module 250. In cases where a body part is associated with a respective weight, analysis module 250 can compute the angular difference between body parts, and associate the computed angular difference with the respective weight of the body part. The similarity aspect score can be calculated according to the associated respective weight. For example, the aggregation of the separate angular differences can be according to the associated respective weight of each body part.

Alternatively or additionally, in some cases, predefined variations of the pose of the trainer are allowed, such that despite a high angular difference between body parts of the trainer and the body parts of the trainee being computed, the high angular difference should contribute less to the similarity aspect score, resulting in a higher similarity score.

Alternatively or additionally, aggregation of the similarity of the separate body parts can be calculated using summary statistics, such as minimum, average, and percentile. Yet, in some examples, the aggregation can be also learnt using known per se machine learning methods by mapping the distances of one or more body parts to an overall similarity score. For example, machine learning methods can include regression, neural networks, or statistical approaches.

The calculated similarity scores can be stored by analysis module 250, e.g. in memory 220.

In some cases, the calculated similarity score of the candidate frames can be transformed, giving rise to the move performance score (block 1060 which corresponds block 780 in FIG. 7).

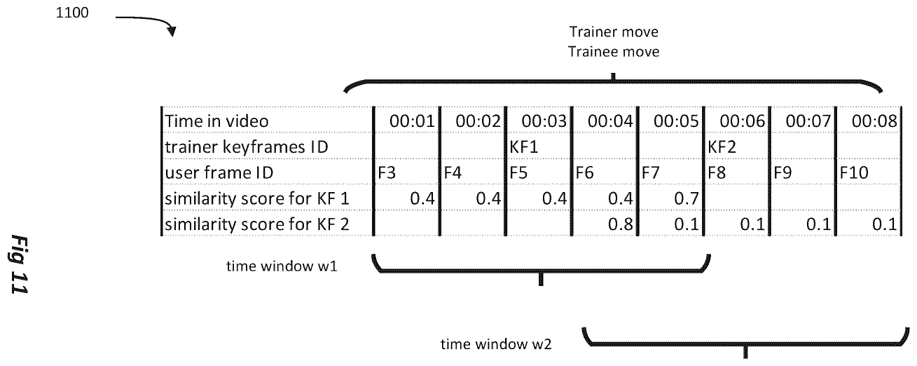

Reference is now made to FIG. 11 illustrating exemplary timelines 1100 of the trainer keyframes and the trainee frames, similar to those illustrated in FIG. 8, in accordance with certain embodiments of the presently disclosed subject matter. It should be noted that the time window w1 of candidates F3-F7 is identical to that illustrated in FIG. 8, while the time window w2 for KF2 is now defined to include F6 to F10 as candidates to KF2. Also illustrated in FIG. 11 are the results of the similarity analysis including a similarity score for each candidate. For example, F3 has a 0.4 similarity score with respect to KF1 and F7 has a 0.7 similarity score with respect to KF1. F6 has a 0.8 similarity score with respect to KF2 of the trainer. F6 and F7 are candidates of both KF 1 and KF2, and can yield different similarity scores for different trainer keyframes. Also to be noted is that, based on the similarity scores, F7 has the highest similarity score to KF1, and F6 has the highest similarity score to KF2. Based on the similarity analysis, F7 and F6 can be selected as matching frames to KF1 and KF2 from the candidates of each keyframe, respectively.

In some cases, the calculated aspect scores of the candidate frames can be transformed, giving rise to the move performance score. The transformation function is further described below with respect to block 780 of FIG. 7.

In some examples, one or more additional similarity analysis can be performed. The additional similarity analysis can be performed, in order to identify one or more additional insights on the performance of the move, and provide suitable feedback. The additional similarity analysis can be performed based on the same trainee input frames with respect to a second, different, set of trainer keyframes. The second set of keyframes can be predefined based on the keyframes of the trainer, and may reflect typical mistakes or possible variations to the trainer keyframes, for example, wrong limb, mirrored move, swapping of two moves. The second set of keyframes may be stored in memory 220 and obtained by similarity analysis module 250. Additional similarity scores, calculated based on the additional similarity analysis, can be indicative of the performance of the move by the trainee. In case the additional set of keyframes reflects typical mistakes (e.g. an alternative trainer keyframe shows a body pose including hand up instead of the hand down in the trainer keyframe), then, as opposed to the regular similarity analysis, high similarity scores in the additional similarity analysis are indicative of low performance of the move. In case the additional keyframe similarity reflects possible variations, then high similarity scores in the modified similarity analysis are indicative of high performance of a variant of the move. In addition, usage of calculated modified similarity scores to provide a move performance score is further described below with respect to timing analysis.

Attention is now reverted to a description of the timing aspect and calculating a timing score in accordance with certain embodiments of the presently disclosed subject matter. The timing aspect may analyse the timing of the trainee move with respect to the trainer move, while assuming that the trainer timing is accurate, and that the trainee should follow the trainer's timing. The timing analysis may assist in indicating whether the trainee performs the move at the same speed as the trainer. In some examples, based on the timing score that is calculated for the timing aspect, it will be possible to provide the trainee with feedback that his move is too fast, or too slow. In some cases, in order to analyse the timing aspect, it is required to process a segment from the trainer video that includes several trainer keyframes, and to process a corresponding segment from the trainee video that includes corresponding candidate trainee frames. The trainer keyframe and trainee frames in the segments are examined with respect to a plurality of timing parameters. A timing score can be calculated, based on timing parameters.

It should be noted that the timing analysis is independent of the similarity analysis described above, and is related to calculating the timing score with respect to timing parameters. However, processing the timing parameters on frames assumes that some or all of the trainee frames have a matching score indicative of a likelihood of match between the candidate trainee frame to a trainer keyframe. In some examples, the matching score can be calculated based on the similarity analysis, however, this should not be considered as limiting, and those skilled in the art will readily appreciate that the teachings of the presently disclosed subject matter are, likewise, applicable to other matching scores, calculated by other known, per se, techniques.

It should also be noted that while the similarity analysis (or any other matching analysis technique) aims to match a candidate trainee frame to a trainer keyframe in a local manner when considering a trainer keyframe in an individual manner, the timing analysis aims to match trainee frames to trainer keyframes in a more holistic manner, while reviewing the optimal match of trainee frames to keyframes, when considering some or all of the frames in the trainee video. As described further below, in some cases, although the similarity or matching score for a particular trainee frame is high, when timing analysis is performed, the trainee frame may not be selected as a matching frame. The reason is that when processing the entire trainee video and several trainer keyframes, the timing parameters dictate that another trainee frame should be selected as a matching frame. Referring back to FIG. 6, processing the trainee frames in relation to timing may be advantageous in such examples. For trainer KF1, candidate F3 and F4 are processed. Based on the similarity score, F3 would probably be selected, despite being farther from the expected time point of KF1 than F4. Yet, in some examples, processing the timing aspect of F3 and F4, while considering timing parameters with respect to all trainer keyframes in the video, the selection of a matching frame may result in selection of F4.

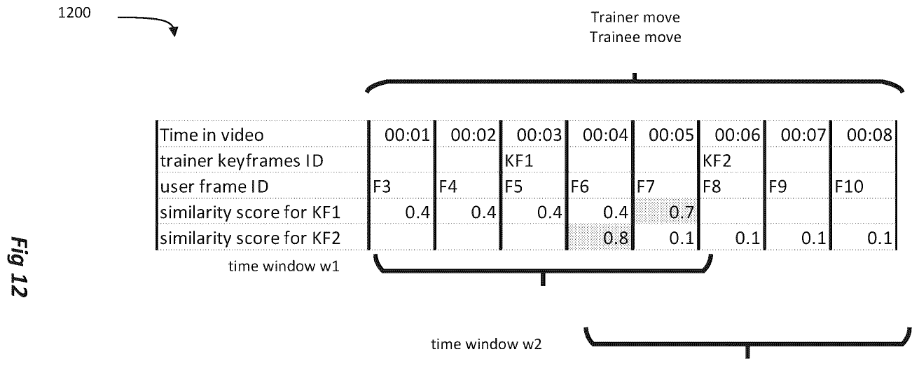

To generally illustrate the timing aspect analysis, an example of an analysis of one timing parameter, the out-of-sync timing parameter, is provided. The general description of the timing analysis, and further examples of timing parameters, are described with respect to FIG. 13 which follows this example. According to the out-of-sync parameter, the order of appearance of the trainee frames in the sequence of keyframes should be the same order of appearance of the trainer keyframes in the sequence. Reference is now made to FIG. 12 illustrating an exemplary scenario of applying the out-of-sync timing parameter, in accordance with certain embodiments of the presently disclosed subject matter. FIG. 12 illustrates a table 1200 of timelines of the trainer keyframes and the trainee frames, similar to those illustrated in FIG. 11. As illustrated also in FIG. 11, candidate trainee frames are associated with respective matching scores. In this example, the matching score were similarity scores, as described above, however, this should not be considered as limiting, and the matching scores in FIG. 12 could have been obtained using known per se techniques of scoring likelihood of similarity to trainer keyframes.

F7 is marked in grey as it has the highest matching score to KF1 of the trainer, from all candidates of KF1. F6 is marked in grey as it has the highest matching score to KF2 of the trainer, from all candidates of KF2. Selecting a matching candidate based on the matching scores only would have result in selection of F7 as matching to KF1, and selection of F6 as a matching KF2. However, if F7 and F6 are selected for matching KF1 and KF2 respectively, the result would be that F6, appearing before F7 in the trainee video, matches a trainer keyframe KF2, that is later than the trainer keyframe that F7 matches, KF1. When considering the example of the move that includes putting the hand down, where KF1 represents when the hand is up, and KF2 represents when the hand is down, in practice, selection of F7 and F6 would mean that the trainee first put down his hand (KF2 of the trainer), and then raised his hand up (KF1 of the trainer), in an opposite manner to the trainer. The holistic approach of processing KF1 and KF2 together, while considering timing parameters, and applying an out-of-sync timing parameter, may result in selection of either one of F3, F4 or F5 as matching to KF1, such that F6 can be selected to match KF2. Applying a timing analysis may therefore be advantageous when aiming to match a trainee frame to a trainer keyframe more accurately, in a holistic and optimal approach, while processing the entire sequence of the trainer keyframes and trainee frames, in order to provide the move performance score.

Referring now to FIG. 13, there is illustrated a generalized flow chart of a timing analysis. In accordance with certain embodiments of the presently disclosed subject matter, the stage of analysing keyframe timing 760 is comprised in calculating an aspect score 740 block in FIG. 7. The stages illustrated in FIG. 13 can be performed e.g. by timing analysis module 260 appearing in FIG. 2.

As described above, the timing analysis assumes that candidate trainee frames have been selected for a trainer keyframe, and that each candidate has been processed to indicate a matching score to the trainer keyframe. Therefore, in some cases, timing analysis module 260 can obtain, for at least two candidate trainee frames, a respective matching score (block 1310). The matching scores are indicative of a likelihood of match between the candidate and a trainer keyframe. In some examples, the matching score can be a similarity aspect score, as calculated by the similarity analysis module, as described above. However, those skilled in the art will readily appreciate that the obtained matching scores, are, likewise, applicable to matching scores calculated by other known per se techniques. With reference to FIG. 12, timing analysis module 260 can obtain the similarity scores of F3-F7 for matching KF1, and the similarity scores of F6-F10 for matching KF2.

Based on the obtained matching scores, timing analysis module 260 can calculate the timing aspect score (block 1320). A trainer time interval from the trainer video can be obtained. The trainer time interval includes at least two trainer keyframes. With reference to FIG. 12, the trainer time interval can include time 00:01-00:08. Based on the trainer time interval, timing analysis module 260 can determine a corresponding trainee time interval in the trainee video (block 1330). The corresponding trainee time interval includes at least two successive candidate trainee frames. The successive candidates have respective matching scores. In some examples, the determined trainee time interval includes the same time interval as that of the trainer interval, at the same appearance in time in the video. For example, with reference to FIG. 12, since the trainer time interval includes time 00:01-00:08 of the trainer video, the determined trainee time interval can also include time 00:01-00:08 of the trainee video.

In some examples, the trainer time interval can include the entire trainer video, and, accordingly, the entire trainee video. Yet, in some other examples, the trainee time interval can be determined based on trainer keyframes that were included in the trainer time interval. The trainee time interval is determined to include all the candidates that correspond to the trainer keyframes included in the trainer time interval. For example, with reference to FIG. 12, the trainer time interval may include time 00:01-00:06 comprising KF1 and KF2 of the trainer. The candidate trainee frames to KF1 and KF2 are F3-F10. Hence, a trainee time interval that includes F3-F10 is determined. In this case, the trainee time interval includes time 00:01-00:08. It should be noted that the determined trainee time interval may be of different length to that of the trainer time interval. In such examples, the candidates in the trainee time interval may be normalized, according to the difference in the time window size of the trainer keyframes and that of the candidates.

In some cases, timing analysis module 260 can calculate a timing score for the at least two successive candidate trainee frames, with respect to one or more timing parameters (block 1340). The out-of-sync example described above is one example of a timing parameter. In some examples, the candidates keyframe can be scored in relation to other candidate frames. Assuming for example a first candidate to a first trainer keyframe, and second and third candidates for a second trainer keyframe. The first candidate is scored in relation to each of the second and third candidates.

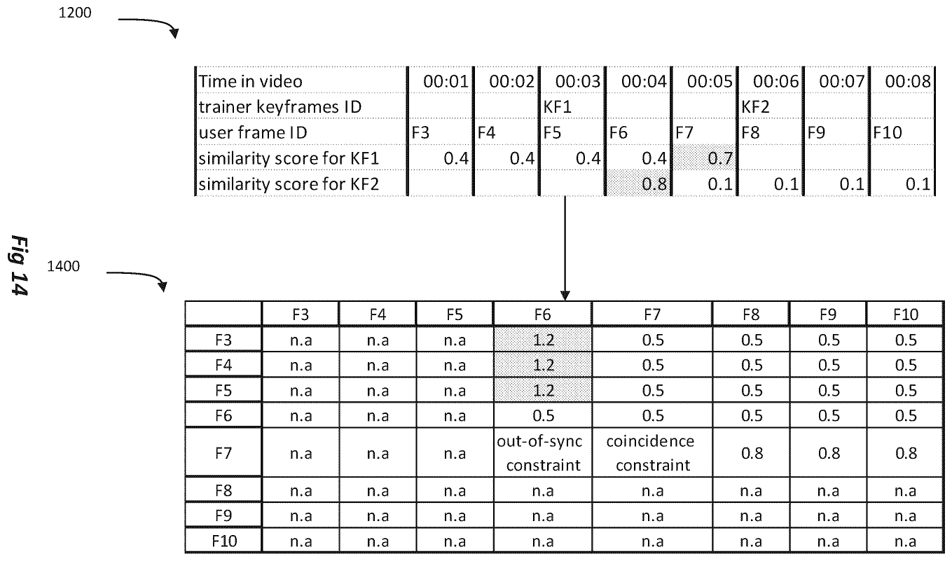

Following is a non-exhaustive list of optional timing parameters. In some examples, a timing parameter may apply a constraint on a candidate trainee frame, e.g. a Boolean constraint, such that if a condition is met, a candidate cannot be selected as a matching frame. This can be achieved e.g. by providing a zero or the lowest optional timing score to a candidate, or by associating an n.a. (not applicable) indication to a candidate, such that no score is applicable for that candidate. In some other examples, a timing score is calculated for a candidate based on a timing parameter, and the timing score may later be aggregated with other aspect scores, e.g. a matching score. Some optional timing parameters include at least:
Matching scores of each candidate with respect to other candidates for other keyframes. This parameter is illustrated with respect to FIG. 14 below.
Time offset between a trainee frame and a trainer keyframe, according to which the time offset between the trainer keyframe and the candidate is calculated, and a substantially similar offset should be applied to all candidates with respect to the trainer respective keyframes. For example, with reference to FIG. 12, consider the first candidate to be F3 for trainer KF1, and the second and third candidates to be F6 and F7 for KF2. Considering the time offset parameter:
the time offset of F3 from KF1 is −2 seconds,
the time offset of F6 from KF2 is −2 seconds, and that
the time offset of F7 from KF2 is −1 seconds.

The timing offset score of F3 would be an array of scores, including a cell of offset score with a high offset score for F6 and a low offset score for F7. An exemplary matrix including scores of each frame with respect to other frames is described below with respect to FIG. 14.
maximum allowed time offset between a trainee frame and a trainer keyframe;
a time constraint not to match the same trainee frame to two different trainer keyframes;
minimal lag between two matching trainee frames that is higher than a predefined threshold, e.g. 50% threshold, of the distance of the trainer keyframes' lag. It is to be noted that the 50% threshold is only an example, and various thresholds can be determined and applied;
trainee frame time compared to trainer keyframe time—a higher timing score will be given to a frame with a time that is closer to the keyframe time;
Clipping keyframe scores below that are floored to a predefined value (for example a clipping threshold of 0.5 would mean a matching score of 0.3 is floored to 0.5).

The above examples should not be considered as limiting, and those skilled in the art will readily appreciate that the teachings of the presently disclosed subject matter are, likewise, applicable to other examples of timing parameters.

Based on one or more parameters of the above, a timing score can be calculated for a candidate frame. For example, the timing score can be the score calculated for offset timing parameter and can be in absolute seconds, preserving the sign or some transformed value based on the raw difference (e.g. based on a non-linear kernel). In cases where the timing score is based on more than one timing parameter, the timing score can be calculated, e.g. by aggregating the timing score of some or all parameters. In case one or more of the parameters is associated with a weight, the timing score can be calculated based on the associated weight.

In cases where, for each trainer keyframe, only one candidate frame is selected from the trainee video, the timing analysis may be skipped, or may be performed under determination that synchronization exists between the trainer keyframes and the trainee frames, and provides an equal timing score for each of the trainee frames. However, in cases where several candidates are selected for one trainer keyframe, it may be advantageous to select one of the candidates as a matching trainee frame for each trainer keyframe. Hence, in some examples, after timing scores are calculated, the timing scores and the matching scores of each candidate frame can be aggregated to provide an optimality score (block 1350). The optimality scores can be indicative of an optimal selection of a matching candidate to a trainer keyframe. In some examples, the timing score and the optimality score can be indicative of a score of a frame with reference to another frame. This is further described below with respect to FIG. 14.

After calculating an optimality score, in some examples, the candidate having the highest optimality score can be selected as a matching trainee frame for a trainer keyframe (block 1360). In some cases, selecting a matching frame is performed where more than one aspect of performance is evaluated, e.g. when similarity analysis and timing analysis are processed. This selection is further illustrated in FIG. 14 below.

In some examples, a threshold may be determined for calculating optimality scores and selecting a matching candidate. In such examples, calculating optimality scores in the timing analysis can be performed only for candidates having a matching score above a predefined threshold. A reason is that if no frame is associated with a similarity score which is above a certain threshold, then there is no point in calculating optimality scores and selecting a matching frame based on the optimality scores. However, it is still advantageous to select a matching frame to each keyframe, e.g. to indicate of the error. Therefore, in such cases the matching frame may be selected based on one or more timing constraints, e.g. based on ‘proximity to expected time’ timing parameter and ‘time offset’ from the keyframe.

In some examples, after selecting a respective matching candidate for keyframes, a move performance score can then be calculated based on the calculated timing score, the optimality score, the matching scores or a combination thereof (block 1370).

Reference is now made to FIG. 14 illustrating an exemplary matrix 1000 of applying timing parameters, calculating timing scores and optimality scores for each candidate frame, in accordance with certain embodiments of the presently disclosed subject matter. After timing scores are calculated, a respective matching trainee frame can be selected for the trainer keyframe.

The illustration of FIG. 14 provides an example of a timing score calculation based on several timing parameters. The first timing parameter to apply is aggregation of matching scores, for example, the matching scores of table 1200 appearing in in FIG. 12. As illustrated in matrix 1400, each frame (F3-F10) is scored during the timing analysis stage, based on the matching score of the candidate to a trainer keyframe, and the matching score of each other candidate with respect to each other trainer keyframes.

For example, consider trainer keyframes KF1 and KF2 only. In table 1200, F3 has a similarity score of 0.4 for similarity to trainer KF1. This similarity score is aggregated to each similarity score of any other candidates F6-F10 of KF2, resulting in the following aggregated scores for F3:

| | F3 | F4 | F5 | F6 | F7 | F8 | F9 | F10 |
|---|---|---|---|---|---|---|---|---|
| F3 | n.a | n.a | n.a | 1.2 | 0.5 | 0.5 | 0.5 | 0.5 |

As shown in the above rows, F3-F5 were not candidates of KF2, hence, no scores could be aggregated and the aggregated scores for each of the cells F3/F3, F3/F4 and F3/F5 is denoted by n.a. F6 was scored with 0.8 for similarity score for KF2, hence, the aggregated score for cell F3/F6 is 1.2 (0.4+0.8). F7 was scored with 0.1 in similarity score for KF2, hence, the aggregated score for cell F3/F7 is 0.5 (0.4+0.1).

As mentioned above, some of the timing parameters may apply a constraint on a candidate trainee frame, e.g. a Boolean constraint, such that if a condition is met, a candidate cannot be selected as a matching frame. As illustrated in table 1200, F7 was scored with 0.7 in similarity score for KF1 and F6 was scored with 0.8 in a similarity score for KF2, which should have been resulted in aggregated score 1.5 in cell F7/F6. However, out-of-sync parameter is applied to F7/F6, in this case, a constraint that the order of appearance of the trainee frames in the sequence of keyframes should be the same order of appearance of the trainer keyframes in the sequence, resulting in no aggregated score in cell F7/F6. For similar reasons, cell F7/F7 does not include an aggregated score. F7 was scored as both similar to KF1 and to KF2, however, a coincidence constraint prevents from a single frame to match two keyframes, hence, the cell of F7/F7 does not include an aggregated score. It is to be noted that the aggregated scores in FIG. 14 are indicative of scores of frames with reference to another frames.

The aggregated scores calculated based on the aggregated matching scores in the above F3 row are also the optimality scores for frame F3. As illustrated, Matrix 1400 illustrates the optimality scores for all candidates.

The optimality scores for each of cells F3/F6, F4/F6 and F5/F6 equals 1.2. The scores are marked in grey to indicate that these scores are the highest scores in the table. Each of these cells is indicative that selecting one of F3/F4/F5 for matching KF1 and selecting F6 for matching KF2 would yield the highest score for the trainee in overall view of the entire move. In the current, the highest optimality scores yield three equally suitable matchings. In these three matchings, trainee F6 is matched with trainer KF2, but the optimality score could equally well match trainee F3, F4, or F5 to trainer KF1.

In some other examples, additional constraints and/or timing parameters in the timing analysis may be applied to select one matching candidate. For example, in the case of equally optimal matches, the candidate with the closest time to the expected KF time is selected (in this case F5 is closest in time to trainer KF1 and hence and will have a higher score over F4. F4 in turn, will have a higher score over F3). Additional constraints can be added, as described above, on the minimum distance between consecutive selected candidate frames (assume at least 1 second difference), or similar time offset between keyframes and respective frames. Both of these constraints or timing parameters result in a higher optimality score and selection of F4 over F5 for matching KF1.

The timing scores for the selected matching frames F4 and F6 can be based on one timing parameter, e.g. the difference in the expected and actual times of the keyframes (F4 appeared 1 second sooner than KF1 and F6 appeared 2 seconds sooner than KF2).

In case additional similarity analysis is performed with respect to a second set of keyframes reflecting typical mistakes and/or possible variations, then the calculated modified similarity scores can be used in the above example, together with the similarity threshold, for calculating optimality scores of the candidate frames, to effectively provide a wide range of mistakes of the move in a flexible way.

It should be noted that the above timing analysis was described with respect to one trainer time interval. In some examples, once a first trainer time interval has been processed, candidates are scored, and, optionally, a matching frame is selected for each trainer keyframe in the time interval, the process proceeds by shifting the time interval to process the next trainer keyframes. In some examples, the time interval is shifted based on the distance between the last keyframe in the time interval, and the next successive trainer time interval. In some examples, selecting matching frames for each trainer keyframe, or some of the trainer keyframes, results in a sequence of selected matching frames for trainer keyframes. This sequence of frames, which are a subset of all frames in the trainee video or sequence or images, are the frames in which the trainee tried to imitate the moves of the trainer. Hence, selecting the matching frames, and reaching the sequence of selected frames, achieves to provide a more accurate feedback to the user, which will enable the user to improve his future moves.

In some examples, once a candidate frame is selected as a matching candidate and a move performance score is calculated based on the matching frames a more accurate and efficient feedback can be provided, as the feedback may rely on insights learned and focus on the matching frame and its score, compared to the trainer keyframe. Accordingly, feedback on how the trainee can improve the performance of a future move, when relying on the insights learned from that matching frame, can be provided to facilitate the trainee to improve performance of a future move with respect to the trainer move.

Attention is now reverted to a description of the motion dynamics aspect. While keyframe matching based on similarity and timing aspects may indicate the correctness of the move and its timing, the motion dynamics aspect relates to the style of the move and movement transformation between two trainer keyframes in a move. It should be noted that although the motion dynamics analysis is now described after performing the timing analysis, it should not be considered as limiting, and those versed in the art would realise that motion dynamics analysis can be performed before the timing analysis. Scores calculated during the motion dynamics analysis can be used as matching scores obtained by the timing analysis module 260, as an input to the timing analysis. The motion dynamics scores can be combined with other matching scores, such as calculated similarity scores, or may be used independently as matching scores.

In some cases, in order to process the move in relation to the motion dynamics aspect, successive trainer keyframes in a trainer video, and trainee frames in the trainee video, are processed. Motion features can be extracted from the two successive trainer keyframes and can be analysed in the trainee frames. For example, the velocity of joints' change in the move of the trainer can be compared to the velocity of joints' change in the move of the trainee. Other examples of motion dynamic features appear below.

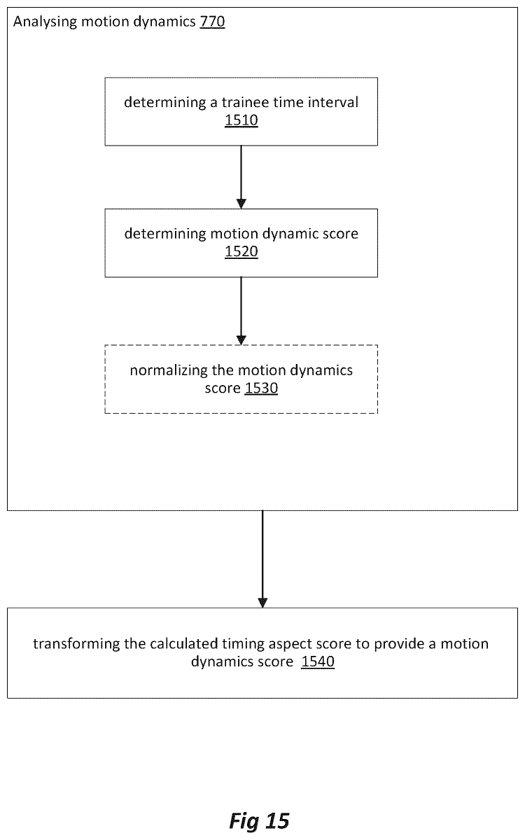

Referring now to FIG. 15, there is illustrated a generalized flow chart of analysing motion dynamics 770 comprised in calculating an aspect score 740 in FIG. 7, in accordance with certain embodiments of the presently disclosed subject matter. The stages can be performed e.g. by motion dynamics module 270 appearing in FIG. 2. A trainer time interval from the trainer video can be obtained. In some examples, a trainer time interval can include the entire trainer video, or a predefined portion thereof, e.g. as defined by the trainer. Alternatively, or additionally, the trainer video may be divided, to include a predefined number of trainer keyframes. In some examples, the trainer time interval may include at least two trainer keyframes.

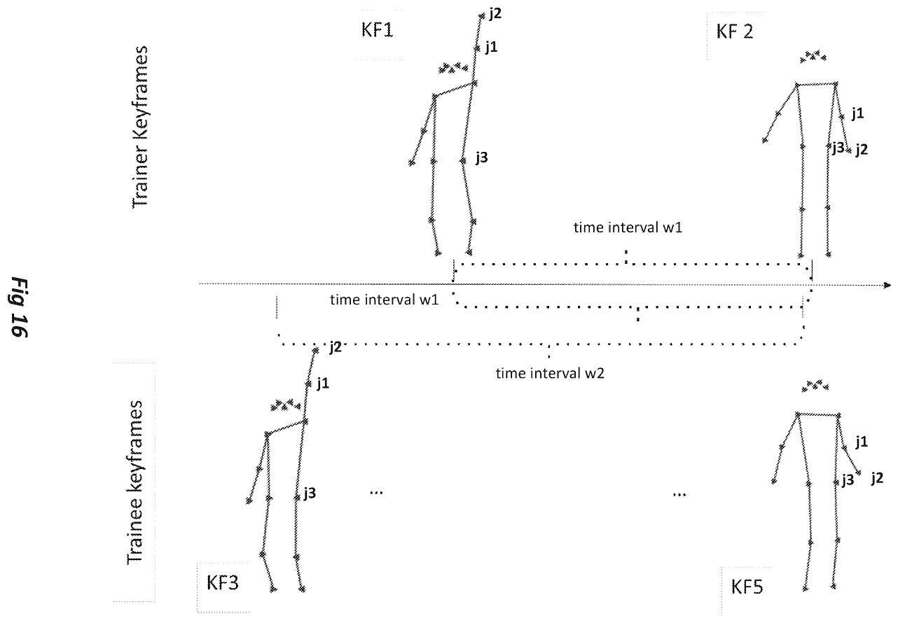

Based on the trainer time interval, motion dynamics module 270 can determine a corresponding trainee time interval in the trainee video (block 1510). Reference is made to FIG. 16 illustrating exemplary timelines of the trainer keyframes and the trainee frames in the respective videos. Trainer time interval is illustrated by time interval w1 from KF1 to KF2. Given a start and end timepoint of time interval w1, a respective start and end timepoints of a time interval in the trainee video can be determined, e.g. time interval w1 in the trainee video. In some examples, the determined trainee time interval includes the same time interval w1 as that of the trainer interval, at the same appearance of time in the video. In some examples, the trainee time interval includes at least two trainee frames.

Yet, in some other examples, the trainee time interval can be determined based on trainer keyframes that were included in time interval w1. In case matching frames have already been selected for each keyframe before motion dynamics analysis is performed, then the trainee time interval can be determined based on the matching frames, and can include at least the respective matching trainee frames to the trainer keyframes included in the time interval w1. With reference to FIG. 16, the respective matching trainee frames to KF1 and KF2 included in time interval w1 are F3 and F5. Hence, a corresponding time interval w2 is determined, which starts at time appearance of F3 and ends at time appearance of F5 in the trainee video. In some examples, the trainee time interval can be determined based on a combination of a fixed predefined size as well as the matching frames, where one point (either the starting or the end time) is determined based on the matching trainee frame, and the size of the time interval is determined based on an absolute predefined window size.

Motion features can be extracted from the trainer keyframes included in the trainer time interval. The motion features can relate to one or more of the following groups of features, or a combination thereof, and can be indicative of movement transformation between two keyframes:
features extracted from the velocity of the joints, e.g. the velocity of change in the joints,
features extracted from the relative motion patterns, e.g. features which compare how joints change in location relative to each other,
features extracted from proximity patterns module, e.g. features which compare if joints are close to each other,
features extracted from turn motion patterns module, e.g. features which compare the similarity of turns around a specified axis,
features extracted with respect to activity level consideration, (the magnitude of change in location over successive frames, minimally from one frame to the next), including features extracted from a peak of a move. To illustrate a peak of a move, consider an example of a trainer move being a small kick. However, the trainee performed a strong kick. When analysing similarity in the keyframes, the beginning of the trainee motion, where the trainee just started to kick, may be considered as the best match of keyframe. However, the motion dynamics analysis includes analysing the peak of the move, resulting in finding the matching frame of the trainee to be the keyframe including the peak of the trainee strong kick. Despite this keyframe being less similar, it is more accurate, and providing feedback of this matching frame may assist the user in performing his future move in a more accurate manner.

The above list should not be considered as limiting, and those skilled in the art will readily appreciate that the teachings of the presently disclosed subject matter are, likewise, applicable to other motion features.

FIG. 16 illustrates movement transformation between two keyframes. The velocity of change in the position of joint j2 in KF1 to KF2 can be extracted, and compared to the velocity of change in the position of joint j2 in F3 to F5. If the velocity measured in the trainer keyframes is high, whereas the velocity measured in the trainee frames is low, then the difference can be indicative of low performance of the move in terms of the motion dynamics aspect, resulting in a low motion dynamics score. Another example of a motion feature includes measuring the change in distance between joint j1 and j3 in KF1 and the same distance in KF2, when compared to the change in distance of j1 and j3 in F3 and F5. If, for example, the change in the measured distance between j1 and j3 in trainer keyframes KF1 and KF2 is different from the change in measured distance between j1 and j3 in F3 and F5, then this can be indicative of low performance of the move. For example, the difference can indicate of a larger or smaller change. In some examples, the shape of timeseries of j1 and j3 distances between F3 and F5 can also be compared.

Referring back to FIG. 15, based on at least one motion feature extracted from the at least two trainer keyframes included in the trainer time interval, motion dynamics module 270 can determine a motion dynamics score for the matching trainee frames (block 1520). For example, one or more scores can be calculated with respect to one or more motion dynamics features, and be aggregated to provide a motion dynamics score.

Each of the trainer time interval and the corresponding trainee time interval may be associated with a window size. In some examples, the window size associated with the corresponding trainee time interval is different than the window size associated with the trainer time interval, as illustrated by time intervals w1 and w2 in FIG. 16. In some examples, in order to better compare motion dynamic features on the trainee frames the calculated motion dynamics score can be normalized according to the window sizes. In order to normalize the motion dynamics score, a difference between the window sizes of the trainer and corresponding trainee time intervals can be calculated. In accordance with the difference of window sizes, the respective motion dynamics scores of the matching trainee frames can be normalized (block 1530), e.g. using known per se techniques.

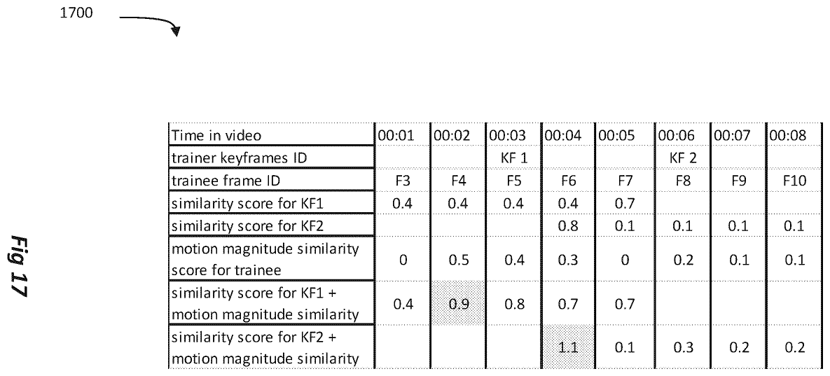

Referring back to FIG. 7, the similarity analysis, timing analysis and motion dynamics analysis are three examples of aspects of the performance. The analysis of these aspects is described with respect to calculating an aspect score in block 740 in FIG. 7. As described above, each of the aspects can be applied independently of the other. Yet, the trainee frames can be analysed with respect to more than one aspect. Reference is made to FIG. 17 illustrating implementation of analysing the trainee frames according to the three aspects. As illustrated in table 1700, the trainer video includes two keyframes KF1 and KF2. The trainee video includes trainee frames F3-F10. Based on trainer keyframes KF1 and KF2, a time window of +/−2 seconds with respect to trainer keyframes is selected. Accordingly, candidate trainee frames F3 to F10 are selected.

A similarity analysis is then performed to F3-F10, and a similarity score is computed for each F3-F10, as illustrated in the similarity score with respect to KF1 and KF2. As illustrated, F6 and F7 are candidates of both KF1 and KF2, and can yield different similarity scores for different trainer keyframes. Also to be noted, is that, based on the similarity scores, F7 has the highest similarity score for KF1, and F6 has the highest similarity score for KF2.

Next, motion dynamics analysis is then performed to F3-F10. In this example, motion magnitude similarity feature is performed, to consider the peak of the motion of the trainee. Motion magnitude scores are listed in table 1700.

The scores of the dynamic motion analysis and the similarity analysis can be aggregated, referred to in table 1700 as ‘similarity score for KF1+motion magnitude similarity’ and ‘similarity score for KF2+motion magnitude similarity’.

In some examples, the aggregated scores illustrated in table 1700 can constitute matching scores for next to be performed timing analysis. F4 and F6 have the highest matching scores for KF1 and KF2.

Next, timing analysis is performed for a more holistic process of the frames. The timing analysis may add constraints of the selection of matching frames, or compute a low timing score for the frames, resulting in different selection of matching frames when timing aspects is further processed. For example, the timing analysis can include a constraint of out-of-sync keyframes, offset parameters and such.

In the example of table 1700, the timing constraints that are applied (now shown) do not change the scores, and as such, F4 and F6 remain as having the highest scores, now being optimality scores for F4 and F6. These frames can be selected as matching to KF1 and KF2 respectively. The timing scores of F4 and F6 can be based on offset timing parameter to be −1 and −2, respectively.

The scores calculated for F3 and F6 for the various aspects can be fused to provide a move performance score and a suitable feedback.

It should be noted that the above is merely an example of the order of performing the aspects analysis. A different order of execution can be determined, e.g. based on the type of the move that the trainee tries to imitate. For example, for freestyle dances, it may be advantageous to select a different order, such that first the motion activity level is evaluated to calculate a motion dynamics score, then the timing analysis is evaluated based on the scores of the motion dynamics (constituting the matching scores for the timing analysis). Once the matching candidates are selected in the timing analysis, only then, keyframe similarity aspect scores are calculated for the matching frames. A move performance score can then be calculated based on the calculated scores, and a suitable feedback can be provided.

Referring back to FIG. 7, once one or more aspects scores are calculated, PMC 210, e.g. using transformation module 280, can transform the calculated aspect scores, giving rise to the move performance score (block 780). Based on the move performance score, feedback to the trainee can be provided (block 792), whereby the feedback that was provided to the trainee facilitates the trainee to improve the performance of a future move with respect to the trainer move.

In some examples, the similarity, timing and motion dynamics analysis provide indication on different aspects of the performance of the move. Transforming the computed scores of the aspects into a move performance score, based on which feedback is provided, is advantageous, since the aspect scores may be translated to high-level concepts of accuracy, timing, and style. The feedback may then be focused on specific aspects according to the scores, such that it facilitates the trainee to improve his/her performance. Thus, the learning process of the trainee imitating a trainer may go through different qualitative stages.

In cases where only one aspect is evaluated, a move performance score can be calculated based on transformation of the scores calculated for each feature or parameter in that aspect. For example, average, geometric mean or based on a learned method considering the individual scores informativeness can be performed to transform the scores into a move performance score.

In cases where trainee frames are processed in relation to more than one aspect, transforming the scores to provide a motion dynamics scores include fusing the scores of the various aspects (block 790). In some examples, in order to fuse one or more aspect scores, the scores of the matching frames and/or transformations thereof can be aggregated. In some other examples, the aggregation can be conditional, such that the transformation function of one calculated aspect score is determined or weighted based on one or more conditions pertaining to another calculated aspect score of a second aspect. The conditional aggregation is advantageous to provide a more accurate move performance score, since, as explained further below, different weights may be given to different aspects, depending on the scores of the aspects. For example, if no trainee frame is scored with a high similarity score, there is no relevancy to the timing, and hence the timing scores and motion dynamics score may be weighted with zero. In some examples, one or more weights for one or more aspects can be predefined.

Alternatively or additionally, the fusion of the aspects scores may include creating a summarization function, which depends on the aspects scores, or a combination thereof. One example of combining the aspects scores includes a three parameter function, for example:

| | |
|---|---|
| If | similarity score > first threshold |

then

motion dynamics score= w1*similarity aspect

score+w2*timing aspect score+w3*motion dynamics score
else

motion dynamics score = w3* similarity aspect score

where w1, w2 and w3 are predefined weights.

In another example the following function can be applied:

w1*similarity aspect score+w2*1*timing aspect score+w3 motion dynamics score

Therefore, not only a hard ‘if’ threshold can be used but a lower threshold, including a logistic function, can also modulate the effect of one aspect score on another.

The fusion functions can be predefined and applied when necessary, or can be learned, using known per se machine learning modules.

Reference is made back to block 440 in FIG. 4. The result of processing the at least one trainee move with respect to at least one corresponding move included in the selected segment is obtaining a segment performance score. The segment performance score is indicative of a performance of one or more trainee moves in relation to one or more corresponding moves of the selected segment. In some cases, based on the segment performance score, feedback is generated (block 490) and is provided to the trainee's device (block 492), e.g. by feedback module 290 of FIG. 2. In some examples, more than one feedbacks are generated and provided. The provided feedback facilitates the trainee to improve a performance of the motor skill with respect to the trainer's motor skill. In some examples, the generated feedback can be saved or shared by the trainee.

In some examples, the feedback generated by feedback module 290 can be audio feedback, textual feedback, and/or visual feedback. For example, visual feedback can include written text, and body part components. The feedback may include specific corrections that should be made in the performance of the move, such that the feedback facilitates the trainee to improve the performance of a future move with respect to the trainer move. For example, the feedback may include a guiding statement of raising the hand all the way up, or being faster. In some examples, the feedback may indicate differences between the performed trainee move and the trainer move, as processed in relation to the aspects of performance, e.g. based on the move performance score. For example, the generated feedback may pertain to one of more aspects of the performance of a move, as analysed by similarity module 250, timing module 260, and motion dynamics module 270. For example, if, according to the similarity analysis of the trainee's move with the trainer's move, it arises that the trainee raised his left arm instead of the right arm, as in the dance in the trainer's video, then, based on the similarity analysis, suitable feedback can be generated. Such feedback can include text indicating to the trainee use of a wrong arm. Yet, in some examples, the aspects of the moves can be summarized in one metric that consolidates the overall performance of the move. Suitable feedback can be provided based on that metric.

Some challenges of learning motor skills lie in the fact that the feedback on the trainee's move should be interpretable and acceptable by the trainee in an efficient manner. As such, even in cases where the similarity analysis yielded a distance function between the move of a trainee and that of the trainer, it is advantageous not only to indicate the distance function, but also to facilitate that this function focusses on relevant aspects in the performed trainee move. For instance, people might do the same move (e.g. ball dribbling, arms wave, or playing the guitar) with a different style. This is likely to result in a distance function indicating a slightly different motion pattern between the moves, but having a high similarity performance. Hence, in such examples, the feedback can pertain to motion dynamics aspects of the move. Another example is when the analysis detects a delay in execution of the moves—based on either alignment of key frames between the trainee and the trainer or alignment of the videos, the feedback can include a still image or a short video of the trainee video execution potentially with the trainer execution showing the offset in time (i.e. by showing the videos side by side, the trainee can see that their execution is delayed compared to the expected execution of the trainer). Optionally, a short text (Hurry up) or an icon (e.g. a turtle) can further be added, and can assist in providing this feedback.

In case the timing analysis reveals that in a certain move a key frame is not matched and the timing analysis returns (1) that the keyframes are not matched (2) which body part is responsible for the non-match and (3) the location of all joints and body parts in a move as detected by a computer vision algorithm, the generated feedback can be based on the semantic information from (1) and (2) and can include a textual or audio feedback, e.g. “Pay attention to your left arm” or “Try again and correct the move of your left arm”. The feedback can also include visual feedback based on (3), which highlights the body part.

Feedback can also be generated based on meeting pre-defined conditions with respect to timing analysis, keyframe matching, and/or motion dynamics analysis. For example, when a swing with the left arm is late (resulting from the timing analysis) and a robotic move is performed instead of a smooth move (resulting from the motion dynamics analysis), the feedback can include a visual/audio feedback of “move left arm smoothly and a bit sooner on your next try”. In some examples, the feedback can be customized by selecting feedback that corresponds to mistakes performed by the trainee.

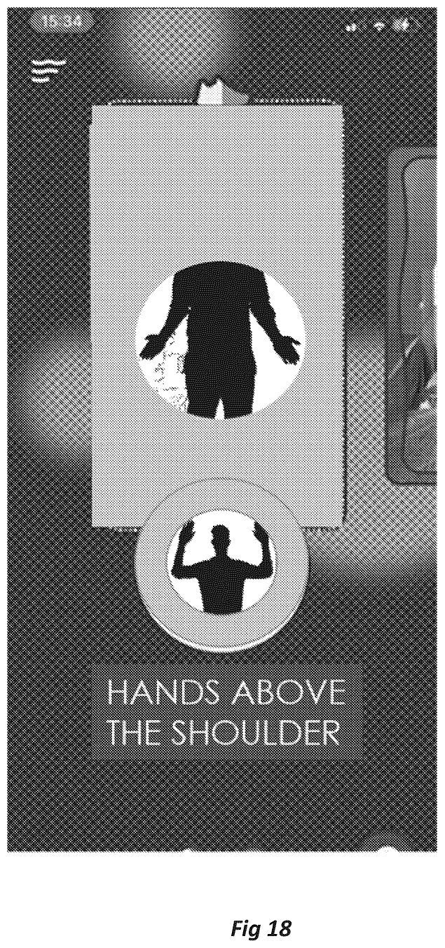

In some examples, based on the similarity analysis, the feedback can include a body part of the trainee/trainer, e.g., a screenshot of the trainee/trainer video with shown body part. Hence, where the trainee move is defined by a set of joints, as e.g. used by the similarity analysis, feedback module 290 can select, based on the at least one aspect of the performance, such as the similarity analysis, a joint included in a processed trainee move to cut out. The generated visual feedback can include at least a display of the selected joint. The relevant body part may be zoomed onto, focused by blurring the rest of the image, or cut out otherwise, to assist highlighting the trainee's mistake. The center of the cutout may be defined based on a present location on the screen, and/or based on the actual joint location, e.g. as detected by the machine learning model. The radius of the cutout may be a predetermined parameter, or may be based on the length of the body part, e.g. the length of the limb, or twice the length of the limb, where the start of the end point of the limb is the target joint that should be the center of the cutout. In some examples, the cutout may be a different geometrical shape and is not constrained to be a circle. The cutout joint may be selected automatically based on the comparison between the trainer and the trainee, or specified in a configuration beforehand. For example, when the cutout is automatically selected, then it can be based on the location of the lowest matching score in the joint-by-joint comparison (e.g. in the similarity analysis). When the cutout is set up in advance, it can be selected based in relation to a certain specific feedback configuration (e.g. a wrist may be the focus for a waving motion). Reference is made to FIG. 18 illustrating feedback including a cutout of the hands.

In some examples, visual feedback can include the trainee video or a manipulation thereof. In some examples, this video is only generated for successful moves or for successful segments. Hence, feedback module 290 can determine whether the segment performance score exceeds a pre-defined threshold, and if in the affirmative, to generate feedback comprising a manipulated version of the trainee video. For example, if the trainee managed to clap his hands on time, the trainee video with animated fireworks at the area and at the time of the clapping can be displayed to the trainee. In some examples, effects and animations can be added to the video as follows:
The location of trainee's joints in 2D and 3D space can be processed and determined by a customized computer vision/machine learning model
The location of trainee's joints can be used to determine the start location of the animations and effects;
The location of the outline of the trainee silhouette is determined by a customized computer vision/machine learning model (e.g. segmentation architectures such as U-Net, FastFCN)
Using the abovementioned, additional effects like e.g. wearables (virtual hats, belts, clothing) or other more sophisticated effects, can be added to the video.

In some examples, the feedback can be generated by identifying and selecting feedbacks from a predefined list of candidate feedbacks. The list of predefined candidate feedbacks can include semantic feedback and can be stored in memory 220 in FIG. 2. Feedback module 290 can identify, from the predefined list, at least two feedbacks that are relevant to the performance of the segment by the trainee, and provide them to the trainee. Optionally, feedback module 290 selects one or more of the candidate feedbacks and provides the selected feedbacks to the trainee.

Identifying and selecting one or more feedbacks from a list of predefined feedbacks can be done in accordance with one or more pre-set rules. Below are some non-limiting examples of rules:
Selection of one or more general success/failure feedbacks can be made based on predefined thresholds on the calculated motion performance score. For example, defining 0.3 as the minimum threshold could result in a “Missing move” feedback for a move score of 0.25. Additionally, defining a 0.8 threshold could be used to generate a “Perfect move” feedback for a score of 0.9.
Selection of one or more feedbacks can be made based on predefined thresholds on calculated aspect scores. Feedback based on aspects scores may provide a wider overview on progress in different facets of the learning move. For example, a threshold on the timing score, and any sign of differences between the threshold compared to the score, can be the basis of feedbacks such as “slow down” or “hurry up”.
Selection of one or more feedbacks can be made based on one or more conditions relating to scores of the various aspects. For instance, a condition specifying a high keyframe similarity score (x>0.9) and a high timing score (x>0.9) together with a lower score for motion dynamics aspect (0.5>x>0.0) can be used as the basis of feedbacks, such as “You know now the gist of the motion, pay attention to its stylistic aspects”.

In some examples, feedback module 290 can filter out at least one candidate feedback, e.g. based on a history of feedbacks provided to the trainee, and provide the remaining candidate feedback to the trainee, without the filtered out candidates. Tracking the history of feedback facilitates providing feedback that has a higher likelihood of acceptance and implementation by the trainee. This can be reached e.g. by learning system 100 storing in memory 220 the feedbacks previously provided to the trainee. When the next feedback is to be provided to the trainee, feedback modules can retrieve the feedback history for the move for the trainee's previous performances. One implementation would filter out an already triggered feedback on a subsequent try (e.g. if trainee received “left hand should be straight” in trial 1 and on trial 2 “left hand should be straight” and “left hand should point upward” are the candidate feedbacks, then the first is filtered and the second is shown to the trainee). A more complex implementation can include the feedback module 290 tracking of how many trials in the past certain feedback was provided, and filter out and weight the probability of the feedback again in function of that (e.g. if it a certain feedback was shown 3 trials ago then there is a 80% chance that it is going to be shown, whereas if it was 1 trial ago, then there is a 20% chance that it is shown). Such functions may be predetermined or alternatively learned from a trainee's history, or from a larger group of trainees' history data, e.g. using machine learning methods.

In some examples, feedback module 290 can associate a priority to the candidate feedbacks, based on pre-set priority rules, and can provide the one or more candidate feedbacks to the trainee's device having the highest priority. In some examples, the pre-set priority rules are selected from a group comprising: affected body parts of the trainee in the trainee move, specificity of the feedback, history of provided feedbacks, and affected part of the move. Affected body parts can include providing a higher priority to certain body parts based on the trainer move. Specificity may be related in at least two ways; first, specificity can be defined to include the number of joints that should be checked for the feedback condition (left arm wrong<both arms wrong). In such a case, the fewer joints have to be checked against the more specific the feedback that should be provided. Second, specificity may be additionally specified or overwritten by an editor during the set up of the dance. For example, assuming the following three feedbacks are detected:
1. Missing move
2. The arms are wrong
3. Left arm is wrong

Feedback module 290 can associate a priority of each of the three feedbacks based on specificity, yielding a high priority to “arms wrong” feedback compared to “missing move” feedback, and even higher priority to “left arm wrong” feedback, which may result in providing the “left arm wrong” feedback to the trainee solely. The editor may decide to nevertheless assign the highest priority to a missing move feedback which overrides this default behavior, and triggers the “missing move” feedback to the trainee.

In some examples, a personalized learning experience of the trainee can be achieved by providing customized feedback. Feedback module 290 can customize one or more of the generated feedbacks, where the feedback includes at least the trainee video, and provide the customized feedback to the trainee's device.

For example, the customized feedback can include one or more visual cues. The visual cues are also referred to above as visual guidance. The visual cues can be added to the trainer or the trainee videos to highlight a body part or other details of the trainer's or the trainee's move during the presentation stage. Similarly to the visual guidance, a visual overlay can be incorporated on the trainer or the trainee video. The visual overlay can be displayed alongside the videos and/or over one or more of the videos, e.g. by superimposing it on the trainer's or the trainee's videos. The visual overlay can include one or more visual cues including symbols highlighting portions of a move, such as circles, directional arrows, springs, wave, balls, lightning, and others. Based at least one the processed trainee move, feedback module 290 can obtain at least one visual cue, e.g. by retrieving it from memory 220. Feedback module 290 can determine in real time a location on the received trainee video suitable for superimposing the visual cue, and to customize the generated feedback by superimposing the obtained visual cue on the trainee video at the determined location. In some examples, feedback module 290 can determine a time duration for superimposing the visual cue, and superimpose the visual cue on the trainee video for the determined time duration. In some examples, more than one visual cue is superimposed on the trainee video.

In some examples, the feedback is provided in a manner that facilitates displaying the generated feedback, in real time, simultaneously to displaying of the selected segment, during the performance of the move or the segment, after the end of the segment, or after the dance. The feedback can include negative and/or positive feedback. In some examples, in order to facilitate learning, one negative feedback and one positive feedback can be shown to the trainee.

In some examples, a feedback can include one or more general feedbacks indicative of progress of the performance with respect to the motor skill, e.g. while considering the previous learning performances of the trainee. Additionally or alternatively, the feedback can include one or more feedbacks pertaining to performance of the selected segment, such as feedback on specific body parts or aspects of the moves in the segment. As illustrated in FIG. 18, the screenshot includes a shoe at the top of the screen, with a partial fill, indicating that the trainee reached an average score on the segment. As also illustrated in FIG. 18, specific feedback on the hands can be provided by highlighting the wrong direction of the hands.

In some cases, the motor learning of the motor skill by the trainee, as referred to above also as a journey flow in the learning phase, includes executing, in a repetitive manner: providing the segments to the trainee, selecting one segment, performing the selected segment, processing the performance of the trainee, and providing a feedback. Performing the segments of the motor skill and receiving feedback for each segment, facilitates the motor learning of the motor skill by the trainee. Hence, in some examples, the motor learning of the motor skill comprises executing in a repetitive manner the stages illustrated in FIG. 4 (as shown in FIG. 4 by a dashed line), where for each current iteration of the execution the trainer video with the plurality of segments is provided, data indicative of a current selected segment displayed to the trainee is received, the trainee video performing the moves of the current selected segment is received and is processed to obtain a current segment performance score, and, based on the current segment performance score, a feedback is generated and is provided. In some examples, the segments are provided in a hierarchy, such that segments can be selected in an efficient manner according to their level in the hierarchy. In some examples the journey menu can be updated with the flow of the trainee, e.g. the items that the trainee chose to traverse. For example, each item that was selected and displayed can be marked in the menu, e.g. by highlighting the item. In some examples, the journey menu will be updated differently for every trainee, e.g. according to traversing and selection of the items/according to the selection of the PMC 120 of the next segments to display. In some examples, the journey menu, e.g. as illustrated in FIG. 3, can reflect the journey flow, i.e. the order of the items selected by the trainee. Hence, a different selection order by the trainee at different times, or by different trainees, will generate different journey flows, yielding a personalized and efficient learning method for each trainee.

As explained above, in some examples, during learning, the trainee can move to the next segment either by reaching a passing score of the current segment, as calculated by PMC 120, in which case, an automatic traversion occurs by PMC 120, or by selecting freely any segment that is displayed in the menu, e.g. to execute manual traversion. The next segment with the automatic traversion can be a next segment in the journey or the next segment in the journey without passing score. This assists in achieving an expert guided traversion based on the score of PMC 120, along with the flexibility of individual selection of segments. In some examples, the next segment that the trainee will learn when passing to the next segment after succeeding the current segment, can be a segment that the trainee has not yet passed in the past, irrespective if this segment is the next segment in the order of segments according to the dance. Considering an example of a dance including 3 segments, moves 1-2, 3-4, 5-7, and a trainee succeeded in the past segment 3-4, and is now trying segment 1-2, when passing segment 1-2, the trainee will automatically move to the next segment of segment 5-7. Upon completion of the current segment, PMC 120 can determine a next segment of the plurality of selectable segments to be displayed to the trainee, select the segment, and provide data indicative of the next selected segment, e.g. to displaying module 232, thereby facilitating displaying the next selected segment upon completion of displaying the current selected segment. Additionally, the data can be reflected in the journey menu.

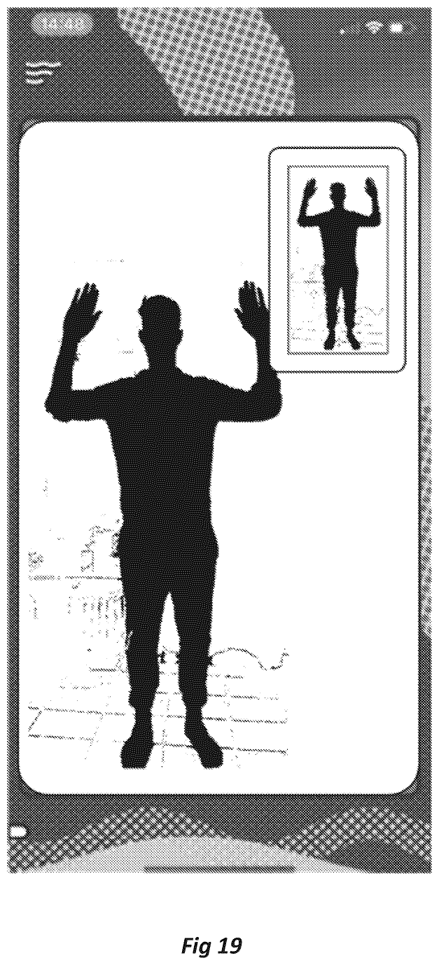

In some examples, the segment can be displayed along with a visual aid of a countdown to start of the presentation of the trainer's video. In some examples, the countdown may be replaced by a recognition of the target's body pose of the trainer in the trainee body pose. For example, the trial of the current segment or move may start when the trainee reaches a standing straight pose, or, when the trainee takes the starting position of the current segment (this may be displayed on the screen). As shown in FIG. 19, the trainee has reached the target body pose by also spreading her arms to the sides. The countdown and the adaptive recognition can be also combined and displayed together to the trainee. In some examples, the correct position to take is according to the position that was taken at the end of the previous segment.

The above examples should not be considered as limiting, and a those skilled in the art will readily appreciate that the teachings of the presently disclosed subject matter are, likewise, applicable to other examples of predefined conditions on how to select feedback to the trainee.

In embodiments of the presently disclosed subject matter, fewer, more and/or different stages than those shown in FIGS. 4, 7, 10, 13, 15 may be executed. In embodiments of the presently disclosed subject matter, one or more stages illustrated in FIGS. 4, 7, 10, 13, 15 may be executed in a different order and/or one or more groups of stages may be executed simultaneously. For example, stages 450, 460 and 470 can be processed in reverse order, or simultaneously. In addition, stages 1010 and 1020 can be processed in reverse order, or simultaneously.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1-30. (canceled)

31. A computerized method for facilitating motor learning of a motor skill by a trainee in relation to a trainer's motor skill, the method comprising: providing a trainer video, the trainer video including a trainer's motor skill, the trainer's motor skill including a plurality of consecutive moves, wherein the trainer video is divided into a plurality of selectable segments to be displayed to the trainee's device, wherein each selectable segment includes at least one move of the plurality of consecutive moves;
receiving data indicative of a selected segment of the plurality of selectable segments displayed to the trainee;
receiving a trainee video comprising at least one trainee move;
processing the at least one trainee move with respect to at least one corresponding move included in the selected segment to obtain a segment performance score, indicative of a performance of the at least one trainee move in relation to the at least one corresponding move of the selected segment;
based on the segment performance score, generating at least one feedback; and
providing the at least one generated feedback to the trainee's device;
whereby the provided feedback facilitates the trainee to improve a performance of the motor skill with respect to the trainer's motor skill.

32. The computerized method of claim 31, wherein at least one selectable segment includes at least one manipulated form of a move of the plurality of consecutive moves, wherein providing a trainer video further comprises providing an indication of the manipulation.

33. The computerized method of claim 32, wherein at least one manipulated form of the move is a slow-motion form of the move.

34. The computerized method of claim 32, wherein at least one manipulated form of the move includes superimposing a visual guidance on the trainer video.

35. The computerized method of claim 31, wherein at least two selectable segments include at least one overlapping move.

36. The computerized method of claim 31, wherein the trainer video is divided into a hierarchy of the plurality of selectable segments representing a hierarchical learning flow, wherein a selectable segment at a higher level of the hierarchy includes: (i) all the moves included in at least one lower level selectable segment of the hierarchy and, (ii) at least one move of the plurality of consecutive moves that is not included in the at least one lower level selectable segment of the hierarchy.

37. The computerized method of claim 31, wherein processing the at least one trainee move is done with respect to at least one aspect of the performance of the at least one trainee move, wherein the at least one aspect is similarity.

38. The computerized method of claim 31, wherein processing the at least one trainee move is done with respect to at least one aspect of the performance of the at least one trainee move, wherein the at least one aspect is timing.

39. The computerized method of claim 31, wherein processing the at least one trainee move is done with respect to at least one aspect of the performance of the at least one trainee move, wherein the at least one aspect is motion dynamics, or a combination of similarity aspect, timing aspect and motion dynamics aspect.

40. The computerized method of claim 31, wherein the at least one generated feedback includes at least general feedback pertaining to the performance of the motor skill and specific feedback pertaining to the performance of the selected segment.

41. The computerized method of claim 31, wherein processing the at least one trainee move is done with respect to at least one aspect of the performance of the at least one trainee move, and wherein a trainee move of the least one trainee move is defined by a set of joints, the method further comprising:
selecting, based on the at least one aspect of the performance, a joint included in a processed trainee move to cutout;
generating visual feedback including at least the selected joint; and
providing the generated visual feedback to the trainee's device.

42. The computerized method of claim 31, wherein generating the at least one feedback further comprises:
identifying at least two candidate feedbacks; and
providing the at least two candidate feedbacks to the trainee's device.

43. The computerized method of claim 42, the method further comprising:
filtering out at least one candidate feedback based on a history of feedbacks provided to the trainee; and
providing the at least two candidate feedbacks to the trainee's device without the filtered out at least one candidate.

44. The computerized method of 42, the method further comprising:
associating a priority to at least one of the at least two candidate feedbacks based on pre-set priority rules, preferably selected from a group comprising: affected body parts of the trainee in the at least one trainee move, specificity of the feedback, history of provided feedbacks, and affected part of the move; and
providing at least one candidate feedback having the highest priority to the trainee's device.

45. The computerized method of claim 31, wherein the at least one generated feedback includes at least the trainee video or a part thereof, the method further comprising:
based on the at least one processed trainee move, obtaining at least one visual cue;
determining, in real time, a location on the received trainee video suitable for superimposing the at least one obtained visual cue; and
customizing the generated feedback by superimposing the at least one obtained visual cue on the trainee video at the determined location.

46. The computerized method of claim 45, the method further comprising:
determining a time duration for superimposing the at least one obtained visual cue; and
superimposing the at least one obtained visual cue on the trainee video for the determined time duration.

47. The computerized method of claim 31, wherein the generated feedback is provided in a manner facilitating displaying the generated feedback, in real time, simultaneously to displaying of the selected segment.

48. A computerized system for facilitating motor learning of a motor skill by a trainee in relation to a trainer's motor skill, the system comprising a processing and memory circuitry (PMC) configured to:
provide a trainer video, the trainer video including a trainer's motor skill, the trainer's motor skill including a plurality of consecutive moves, wherein the trainer video is divided into a plurality of selectable segments to be displayed to the trainee's device, wherein each selectable segment includes at least one move of the plurality of consecutive moves;
receive data indicative of a selected segment of the plurality of selectable segments displayed to the trainee;
receive a trainee video comprising at least one trainee move;
process the at least one trainee move with respect to at least one corresponding move included in the selected segment to obtain a segment performance score, indicative of a performance of the at least one trainee move in relation to the at least one corresponding move of the selected segment;
based on the segment performance score, generate at least one feedback; and
provide the at least one generated feedback to the trainee's device; whereby the provided feedback facilitates the trainee to improve a performance of the motor skill with respect to the trainer's motor skill.

49. A non-transitory computer readable storage medium tangibly embodying a program of instructions that, when executed by a computer, cause the computer to perform a method for facilitating communication with a user device of a user associated with a property in a property location, the method comprising:
providing a trainer video, the trainer video including a trainer's motor skill, the trainer's motor skill including a plurality of consecutive moves, wherein the trainer video is divided into a plurality of selectable segments to be displayed to the trainee's device, wherein each selectable segment includes at least one move of the plurality of consecutive moves;
receiving data indicative of a selected segment of the plurality of selectable segments displayed to the trainee;
receiving a trainee video comprising at least one trainee move;
processing the at least one trainee move with respect to at least one corresponding move included in the selected segment to obtain a segment performance score, indicative of a performance of the at least one trainee move in relation to the at least one corresponding move of the selected segment;
based on the segment performance score, generating at least one feedback; and
providing the at least one generated feedback to the trainee's device;
whereby the provided feedback facilitates the trainee to improve a performance of the motor skill with respect to the trainer's motor skill.

50. In a trainee device, a computerized method for facilitating motor learning of a motor skill by a trainee in relation to a trainer's motor skill, the method comprising:
providing a trainer video, the trainer video including a trainer's motor skill, the trainer's motor skill including a plurality of consecutive moves, wherein the trainer video is divided into a plurality of selectable segments to be displayed to the trainee's device, wherein each selectable segment includes at least one move of the plurality of consecutive moves;
displaying the provided trainer video;
receiving data indicative of a selected segment of the plurality of selectable segments displayed to the trainee;
capturing a trainee video comprising at least one trainee move;
processing the at least one trainee move with respect to at least one corresponding move included in the selected segment to obtain a segment performance score, indicative of a performance of the at least one trainee move in relation to the at least one corresponding move of the selected segment;
based on the segment performance score, generating at least one feedback; and
providing the at least one generated feedback to the trainee's device; whereby the provided feedback facilitates the trainee to improve a performance of the motor skill with respect to the trainer's motor skill.
